(19) United States
(12) Patent Application Publication
(10) Pub. No.: US 2007/0103421 A1
(43) Pub. Date: May 10, 2007

(54) Liquid-crystal display, projector system, portable terminal unit, and method of driving liquid-crystal display

(75) Inventors: Hiroyuki Sekine, Tokyo (JP); Fujio Okumura, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/263,983

(22) Filed: Nov. 2, 2005

(30) Foreign Application Priority Data
Nov. 5, 2004 (JP) 2004-322769

(51) Int. Cl. G09G 3/36

(52) U.S. Cl. 345/100

(57) ABSTRACT

A sequence for applying pulses to control lines in a horizontal period is differentiated for every horizontal period or vertical period and a sequence for data driver circuitry to write signals in data lines in a horizontal period is differentiated for every horizontal period or vertical period so that potential fluctuations of data lines generated at the time of sampling are temporally made uniform so as to make recognition of streak-like irregularity difficult.

### BACKGROUND OF THE INVENTION

1. Field of the Invention

The present invention relates to a liquid-crystal display for time-division-writing video signals for one pixel row and driving method, a projector system on which the liquid-crystal display is mounted, and a portable terminal unit.

2. Description of Related Art

A liquid-crystal projector provided with three liquid-crystal displays corresponding to three primary colors of red (R), green (G), and blue (B) can display a video of a high-luminance, high-definition, and large-screen video. Therefore, the liquid-crystal display is the mainstream of projectors.

A liquid-crystal display used for this liquid-crystal projector normally uses a monochromatic liquid-crystal display in which the diagonal of a display screen is 2″ or less in order to decrease the projector in size and cost. Particularly, because a liquid-crystal display using a P—Si (polysilicon)-TFT (Thin film transistor) has a high mobility of its P—Si-TFT as a pixel transistor formed on each pixel, it is possible to constitute a part of a peripheral circuitry by a TFT on a glass substrate same as pixels. Thereby, a liquid-crystal display provided with a P—Si-TFT is the mainstream of liquid-crystal displays for projectors because it is possible to decrease the display in size and simplify an interface.

As one of the driving methods of this liquid-crystal display, there is a block division driving method (for example, JP6-80477: reference 1). The block division driving method is a method for grouping a plurality of data lines of a liquid-crystal display into a plurality of blocks (groups) and writing video signals for each block.

FIG. 28 is a block diagram showing a conventional liquid-crystal display using a P—Si-TFT. As shown in FIG. 28, in the case of this liquid-crystal display, a TFT-side glass substrate (not illustrated) and an opposite-side glass substrate (not illustrated) are set in parallel and a liquid-crystal layer (not illustrated) is set between the both substrate. Moreover, as shown in FIG. 28, data lines D1 to D9 (also generally referred to as data lines D) are set in the row direction on the TFT-side glass substrate and gate lines G1 to G6 (generally referred to as data lines G) are set in the column direction on the same TFT-side glass substrate. Moreover, a pixel is formed for every most proximity points between the data lines D1 to D9 and the gate lines G1 to G6. That is, a plurality of pixels are arranged like a matrix.

One pixel thin-film transistor TFT, storage capacitor Cs, and pixel electrode Ep are set on each pixel. Either of the source and drain of the pixel thin-film transistor is connected to the data lines D, the other of them is connected to one-hand electrode of the storage capacitor Cs and the pixel electrode Ep. The gate of the TFT is connected to the gate lines G. Moreover, a ground potential is applied to the other-hand electrode of the storage capacitor Cs. Furthermore, a common electrode Eo is set to a position corresponding to each pixel on the opposite-side glass substrate and a pixel capacitor Clc is formed between the pixel electrode Ep and the common electrode Eo.

Furthermore, a data driver circuitry 101 for driving the data lines D and a gate driver circuitry 102 for driving the gate lines G are formed at the outside of a region in which a plurality of pixels are formed on the TFT-side glass substrate. A shift register 103 and analog switches SW1-1 to SW3-3 (hereafter generally referred to as ASW) are set on the data driver circuitry 101. Furthermore, each data line D is connected to any one of video signal lines V1 to V3 through the ASW.

Specifically, the data line D1 is connected to the video signal line V1 through the switch SW1-1, a data line D2 is connected to a video signal line V2 through the switch SW1-2, a data line D3 is connected to a video signal line V3 through the switch SW1-3, a data line D4 is connected to the video signal line V1 through a switch SW2-1, a data line D5 is connected to the video signal line V2 through a switch SW2-2, a data line D6 is connected to a video signal line V3 through a switch SW2-3, a data line D7 is connected to the video signal line V1 through a switch SW3-1, a data line D8 is connected to the video signal line V2 through a switch SW3-2, and a data line D9 is connected the video signal line V3 through a switch SW3-3.

A plurality of data lines D, for example, three data lines D adjacent to each other form a block and ASWs in the same block are controlled by the same control signal. FIG. 28 shows an example in which three data lines belong to one block and there are three blocks. Control signals for controlling ASWs use output signals SR1 to SR3 of the shift register 103. For example, switches SW1-1 to SW1-3 belonging to one block are controlled by the control signal SR1.

Then, a shift register 104 is set to the gate driver circuitry 102 and output terminals of the shift register 104 are connected to gate lines G.

Then, operations of this liquid-crystal display are described below. FIG. 29 is a timing chart showing operations of the data driver circuitry shown in FIG. 28 and FIG. 30 is a timing chart showing operations of the gate driver circuitry shown in FIG. 28. In FIG. 29, a period TH shows one horizontal period for writing a video signal in pixels for one row whose writing is controlled by one gate line of the liquid-crystal display.

In this horizontal period TH, the gate driver circuitry 102 outputs a high-level signal to one gate line Gn and selects the one gate line Gn. Moreover, the shift register 103 of the data driver circuitry 101 successively outputs a control signal for controlling ASWs of each block synchronously with a horizontal sync signal HSYNC input from the outside. Moreover, because video signals are supplied to video signal lines D1 to D3 synchronously with outputs of the shift register 103, video signals are sampled by the data lines D for each block. In FIG. 29, because three data lines D are included in one block, video signals are written for every three data lines D. Furthermore, in this case, because a potential for turning on a pixel transistor TFT is written in one selected gate ling G, the video signals sampled y the data lines are written in the pixel capacitor Clc and storage capacitor Cs through the pixel transistor TFT.

Furthermore, the period TV shown in FIG. 30 shows one vertical period for writing video signals for one screen of a liquid-crystal display. In the vertical period TV, the gate driver circuitry 102 successively writes voltages for turning on a pixel transistor TFT in gate lines G one by one synchronously with a vertical sync signal VSYNC input from the outside. By performing these operations, it is possible to display a two-dimensional video on the liquid-crystal display.

Thus, an advantage of the block division driving method is that the number of terminals for connecting a liquid-crystal display with external circuits can be greatly decreased. The number of terminals required to operate a data driver circuitry and a gate driver circuitry is 10 or less including a power supply and the number of video signal wirings is 30 or less even when the resolution of the liquid-crystal display exceeds XGA (length 1,024×width 768). That is, by connecting approx. 50 terminals, it is possible to drive a liquid-crystal display having a resolution exceeding XGA. However, in the case of a liquid-crystal display using an a-Si (amorphous silicon) TFT used for a display of a notebook-size personal computer, it is necessary to connect 3,000 terminals or more in order to drive a liquid-crystal display having the same resolution. However, by performing block division driving, it is possible to greatly decrease the number of terminal connections compared to the case of the liquid-crystal display using the a-Si TFT.

In addition to the above block division driving method, a method using COG (chip on glass) connection is considered which directly connects an IC (Integrated Circuitry) for supplying a video signal to a data line onto a glass substrate as a method for decreasing the number of connection terminals to a liquid-crystal display. FIG. 31 is a block diagram showing a conventional liquid-crystal display using the COG connection. The liquid-crystal display using the COG is a system frequently used at present as a display for a portable unit.

As shown in FIG. 31, in the case of this liquid-crystal display, the configuration of a gate line, data line, pixel, and gate driver circuitry is the same as the case of the liquid-crystal display shown in FIG. 28. Moreover, instead of the data driver circuitry 101 shown in FIG. 28, a data line driving IC 111 is mounted on a TFT-side glass substrate (not illustrated). A plurality of video signal lines V1 to V3 are set to the data line driving IC 111 and the video signal lines are connected to a plurality of data lines D through ASWs. A plurality of ASWs connected to one output terminal (video signal line V) of the data line driving IC 111 are controlled by different control lines SP1 to SP3. Though not illustrated, a signal and a power supply for operating the data line driving IC 111 are supplied from the outside through electric wirings arranged on the glass substrate of the liquid-crystal display.

By using the above configuration, the number of connection terminals required to operate the liquid-crystal display is formidably small compared to an a-Si TFT liquid-crystal display because the number of terminals for operating the gate driver circuitry 102 is approx. 10 and the number of terminals for operating the data line driving IC 111 is approx. 100.

Then, operations of this liquid-crystal display are described below. FIG. 32 is a timing chart showing operations of the data line driving IC shown in FIG. 31, which is an illustration showing operations of one horizontal period. As shown in FIG. 32, one horizontal period TH is divided into three periods of TB1 to TB3. In the period TB1, the potential of a control line SP1 becomes a potential for turning on an ASW and the ASW connected to the control line SP1 is turned on and a video signal is written in a data line D. Thereafter, in the period TB2, the ASW connected to the control line SP2 is turned on and in the period TB3, the ASW connected to the control line SP3 is turned on, and a video signal is written in the data line D connected to each ASW. Thus, when assuming a plurality of data lines connected to one output terminal of the data line driving IC 111 through ASWs as one block, video signals are successively written in data lines in the block in time division and this operation is simultaneously performed in all blocks.

However, the above prior art has the following problem. It is clarified that a liquid-crystal display for performing the above block division driving and a liquid-crystal display according to COG connection have a problem that a display image quality is deteriorated.

In the case of the block division driving method, even when writing video signals having the same luminance in a portion at an end of a block in which video signals are written in blocks and in a portion other than the former portion, a luminance difference occurs and the difference is recognized as streak-like irregularity. FIG. 33 is an equivalent circuitry showing a configuration nearby an ASW of a liquid-crystal display for performing the block division driving shown in FIG. 28. As already described, in the case of this liquid-crystal display, video signals are written in data lines in blocks in one horizontal period. A block to be controlled by the control signal SR2 is noticed. Video signals are written in the data lines D4, D5, and D6 belonging to this block in the period TB2 and ASWs (switches SW2-1 to SW2-3) are returned to a turned-off state at the end of the period. Then, in the period TB3, writing of video signals in the data lines D7, D8, and D9 is started.

In this case, the capacitive coupling by a parasitic capacitance Cp 6-7 is present between the data lines D6 and D7. When a signal is written in the data line D7 and its potential is fluctuated, the potential of the data line D6 is also fluctuated in accordance with the fluctuation of the former potential. Because this phenomenon occurs in all blocks, the potential of a data line at a block boundary portion becomes a potential shifted from the potential of a written signal. It is a matter of course that a parasitic capacitance between data lines is present not only between adjacent data lines but also between data lines separate from the adjacent data lines. Speaking strictly, an error occurs in potentials of all data lines. Because the magnitude of a parasitic capacitance is maximized between adjacent wirings, an error voltage of a data line located at the boundary portion between blocks is maximized. Because the error voltage causes a luminance difference between pixels and the luminance difference influences all pixels on the same data line, streak-like irregularity along a data line is generated.

For this problem, the present inventor develops a method for decreasing a parasitic capacitance between data lines and decrease streak-like irregularities by applying a shield to a data line and discloses the method in JP No. 3428511. However, it is difficult to completely eliminate parasitic capacitances. When increasing the number of gradations to be displayed on a liquid-crystal display, there is a case in which a streak-like irregularity can be slightly recognized.

Moreover, also in the case of a liquid-crystal display according to COG connection, a problem occurs that a pixel column connected to one of a plurality of data lines connected to one output terminal of a data line driving IC is different from other pixel column in luminance and the luminance appears as streak-like irregularity. This cause is described by referring to FIG. 34. FIG. 34 is equivalent circuitry showing a configuration nearby an ASW of a liquid-crystal display according to the COG connection shown in FIG. 31. As already described, the circuitry performs an operation that one output of data line driving circuitry time-division-writes data in three data lines in one horizontal period.

The data lines D4 to D6 connected to the video signal line V2 of the data line driving IC 111 (refer to FIG. 31) are noticed. A signal is written in the data line D4 in the period TB1 and thereafter, the ASW SW2-1 is turned off, and the data line D4 becomes floating. Then, in the period TB2, a signal is written in the data line D5. Then, potential fluctuation due to writing of a signal in the data line D5 causes potential fluctuation of the data line D4 due to capacitive coupling by a parasitic capacitance Cp4-5.

Then, in the period TB3, a signal is written in the data line D6. By the influence of this writing, potential fluctuation occurs in the data lines D5 and D7. Moreover, in this period, because a signal is also written in the data line D3, the data line D4 is influenced by writing of the signal. That is, the data line D4 receives potential fluctuation due to writing of signal in the data lines D5 and D3 and the data line D5 is influenced by the potential fluctuation due to writing of signal in the data line D6. The data line D6 is not influenced by potential fluctuation because a signal is not written in adjacent data lines D5 and D7 after completing signal writing. Also in this case, speaking strictly, a parasitic capacitance between data lines does not occur only between adjacent data lines. However, a parasitic capacitance between adjacent data lines most influences the potential of a certain data line.

Thus, because the way of receiving potential fluctuation due to writing of a signal in other data line is different between a plurality of data lines to be driven by the same output terminal of data line driving circuitry, a streak-like irregularity occurs similarly to the case of a liquid-crystal display for performing block division driving. However, a liquid-crystal display according to COG connection is used for a direct-sight for a small portable terminal provided with color filters of R, G, and B. Particularly, when the color filters are arranged like a stripe along data lines and the number of data lines to be driven by one output of a data line driving IC is 3, even if voltage fluctuation occurs due to parasitic capacitances of the data lines, it is difficult to recognize the voltage fluctuation as streak-like irregularity because a luminance change is equal between data line of the same color and therefore, it has not been recognized as a problem. However, when setting the number of time divisions to 3 or more (for example, multiple of 3) and using a three-plate-type projector without adding a color filter, this becomes a large problem similarly to the case of a liquid-crystal display for performing block division driving.

### SUMMARY OF THE INVENTION

The present invention is made to solve the above-discussed problems and has as an objective to eliminate streak-like irregularity due to time-division writing in a liquid-crystal display for writing video signals for one pixel row by time-dividing the signals, its driving method, and a projector system on which the liquid-crystal display is mounted, and a portable terminal unit.

A liquid-crystal display of the present invention comprises (n×m)(n and m are integers of 2 or more) data lines extending in the row direction and divided into m groups for every n lines adjacent to each other, a plurality of gate lines extending in the column direction, a plurality of pixels set for every proximity point between the data line and the gate line, gate driver circuitry for successively selecting the gate lines in one vertical period for displaying images for one screen, and data driver circuitry for outputting video signals for one pixel row to the data lines in one horizontal period in which the gate driver circuitry selects one of the gate lines, wherein the data driver circuitry has m output terminals set for every above group to output the video signals, the k-th (k is an integer of 1 to n) switch for switching whether to connect the k-th data line in each group to the output terminals, n k-th control lines connected to all the k-th switches in common, and driving circuitry for successively outputting a control signal for turning on the k-th switches to the k-th control lines and the driving circuitry differentiates a sequence for outputting the control signals to the n control lines in the horizontal period for predetermined period.

In the case of the present invention, it is possible that by differentiating a sequence for outputting a control signal to n control lines belonging to each group in a horizontal period for predetermined period, a sequence for outputting video signals to data lines belonging to each group in a horizontal period is differentiated for predetermined period, a data line in which potential is fluctuated is fluctuated for predetermined period, and only the potential of a data line set to a specific position in each group is prevented from being fluctuated. Thereby, when viewing the whole image, it is possible to eliminate streak-like irregularity.

### BRIEF DESCRIPTION OF THE DRAWINGS

FIG. 1 is a block diagram showing the liquid-crystal display of the first embodiment of the present invention.

FIG. 2 is a timing chart showing operations of the liquid-crystal display of the first embodiment in a certain vertical period by assigning time to the axis of abscissa and potential of each wiring to the axis of ordinate.

FIG. 3 is a timing chart showing operations of the liquid-crystal display of the first embodiment in a vertical period next to the vertical period shown in FIG. 2 by assigning time to the axis of abscissa and potential of each wiring to the axis of ordinate.

FIG. 4 is a timing chart showing operations of the liquid-crystal display of the first embodiment in a vertical period next to the vertical period shown in FIG. 3 by assigning time to the axis of abscissa and potential of each wiring to the axis of ordinate.

FIG. 5 is a timing chart showing operations of the liquid-crystal display of the second embodiment of the present invention in a certain vertical period by assigning time to the axis of abscissa and potential of each wiring.

FIG. 6 is a timing chart showing operations of the liquid-crystal display of the second embodiment in a vertical period next to the vertical period shown in FIG. 5 by assigning time to the axis of abscissa and potential of each wiring to the axis of ordinate.

FIG. 7 is a timing chart showing operations of the liquid-crystal display of the second embodiment in a vertical period next to the vertical period shown in FIG. 6 by assigning time to the axis of abscissa and potential of each wiring to the axis of ordinate.

FIG. 8 is a block diagram showing the liquid-crystal display of the third embodiment of the present invention.

FIG. 9 is a timing chart showing operations of the liquid-crystal display of the third embodiment by assigning time to the axis of abscissa and potential of each wiring to the axis of ordinate.

FIG. 10 is a block diagram showing the liquid-crystal display of the fourth embodiment of the present invention.

FIG. 11 is circuitry diagram showing the gate driver circuitry of the fourth embodiment.

FIG. 12 is a block diagram showing the data-line driving circuitry of the fourth embodiment.

FIG. 13 a sectional view showing the liquid-crystal display of the fourth embodiment.

FIG. 14 is a timing chart showing operations of the data driver circuitry of the liquid-crystal display of the fourth embodiment by assigning time to the axis of abscissa and potential of each wiring to the axis of ordinate.

FIG. 15 is a timing chart showing operations of the data driver circuitry of the liquid-crystal display of the fourth embodiment in a certain vertical period by assigning time to the axis of abscissa and potential of each wiring to the axis of ordinate.

FIG. 16 is a timing chart showing operations of the data driver circuitry of the liquid-crystal display of the fourth embodiment in a vertical period next to the vertical period in FIG. 15 by assigning time to the axis of abscissa and potential of each wiring to the axis of ordinate.

FIG. 17 is a timing chart showing operations of the data driver circuitry of the liquid-crystal display of the fourth embodiment in a vertical period next to the vertical period in FIG. 16 by assigning time to the axis of abscissa and potential of each wiring to the axis of ordinate.

FIG. 18 is a timing chart showing operations of the data driver circuitry of the liquid-crystal display of the fifth embodiment of the present invention by assigning time to the axis of abscissa and potential of each wiring to the axis of ordinate.

FIG. 19 is a timing chart showing operations of the data driver circuitry of the liquid-crystal display of the sixth embodiment of the present invention in a vertical period next to the vertical period in FIG. 18 by assigning time to the axis of abscissa and potential of each wiring to the axis of ordinate.

FIG. 20 is a timing chart showing operations of the data driver circuitry of the liquid-crystal display of the sixth embodiment in a vertical period next to the vertical period in FIG. 19 by assigning time to the axis of abscissa and potential of each wiring to the axis of ordinate.

FIG. 21 is a block diagram showing the liquid-crystal display of the seventh embodiment of the present invention.

FIG. 22 is a timing chart showing operations of the signal processing circuitry of the seventh embodiment by assigning time to the axis of abscissa and potential of each wiring to the axis of ordinate.

FIG. 23 is an illustration showing the polarity of a video signal to be applied to the pixel electrode of each pixel in a certain vertical period.

FIG. 24 is an illustration showing the polarity of a video signal to be applied to the pixel electrode of each pixel in a vertical period next to the vertical period in FIG. 23.

FIG. 25 is a timing chart showing operations of the liquid-crystal display of the eighth embodiment of the present invention by assigning time to the axis of abscissa and potential of each wiring to the axis of ordinate.

FIG. 26 is a block diagram showing the projector system of the ninth embodiment of the present invention.

FIG. 27 is a block diagram showing the liquid-crystal display of the tenth embodiment of the present invention.

FIG. 28 is a block diagram showing a conventional liquid-crystal display using a P—Si-TFT.

FIG. 29 is a timing chart showing operations of the data driver circuitry shown in FIG. 28.

FIG. 30 is a timing chart showing operations of the gate driver circuitry shown in FIG. 28.

FIG. 31 is a block diagram showing a conventional liquid-crystal display using COG connection.

FIG. 32 is a timing chart showing operations of the data-line driving IC-shown in FIG. 31.

FIG. 33 is equivalent circuitry diagram showing a configuration nearby an ASW of a liquid-crystal display for performing the block division driving shown in FIG. 28.

FIG. 34 is equivalent circuitry diagram sowing a configuration nearby an ASW portion of a liquid-crystal display using the COG connection shown in FIG. 31.

### DETAILED DESCRIPTION OF PREFERRED EMBODIMENTS

According to the present invention, it is possible to disperse data lines whose potentials are fluctuated for every vertical period and prevent only the potential of a data line set to a specific position from fluctuating in each group by differentiating a sequence for outputting video signals to data lines belonging to each group in a horizontal period for every vertical period. Thereby, it is possible to eliminate streak-like irregularity.

In the case of the present invention, it is possible to fluctuate data lines whose potentials are fluctuated for every horizontal period or a plurality of horizontal periods by differentiating a sequence for outputting control signals to n control lines in a horizontal period for every horizontal period of one time or a plurality of times and prevent only the potential of a data line set to a specific position in each group from fluctuating. Thereby, it is possible to eliminate streak-like irregularity.

The driving circuitry may differentiate a sequence for outputting the control signals to the n control lines in the horizontal period for every above horizontal period of one time or a plurality of times. Thereby, it is possible to fluctuate the sequence not only for every vertical period but also for every horizontal period of one time or a plurality of times. Therefore, it is possible to more effectively eliminate streak-like irregularity.

Moreover, the liquid-crystal display may have a signal processing circuitry. The signal processing circuitry includes a memory which stores video signals input from a signal source for at least one screen. The signal processing circuitry reads the stored video signals for one screen at a frequency t times (t is an integer of 2 or more) higher than a frequency when input from a signal source, and outputs the read video signals to the data driver circuitry t times in a period in which video signals for the next one screen are input. Thereby, by performing display in accordance with a temporally compressed video signal output from the signal processing circuitry, it is possible to more frequently change the sequence for outputting control signals to n control lines in a horizontal period. Thereby, it is possible to more securely prevent streak-like irregularity.

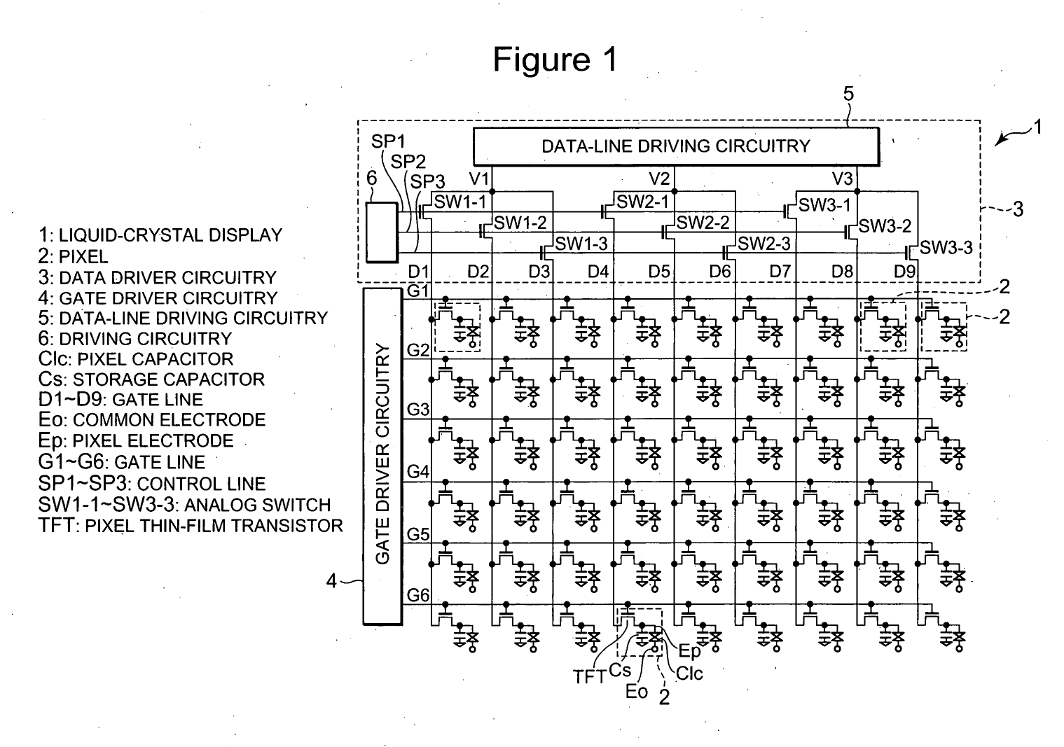

Embodiments of the present invention are specifically described below by referring to the accompanying drawings. First, first embodiment of the present invention is described. FIG. 1 is a block diagram showing the liquid-crystal display of this embodiment. As shown in FIG. 1, in the liquid-crystal display 1, a TFT-side glass substrate (not illustrated) and an opposite-side glass substrate (not illustrated) are set in parallel with each other and a liquid-crystal layer (not illustrated) is formed between the both substrates.

Moreover, data lines D1 to D9 (also generally referred to as data lines D) extending in the row direction are set on the TFT-side glass substrate and gate lines G1 to G6 (also generally referred to as data lines G) extending in the column direction are set on the same TFT-side glass substrate. Furthermore, a pixel 2 is formed at each of proximity points between the data lines D1 to D9 and the gate lines G1 to G6. That is, in the case of this liquid-crystal display, a plurality of pixels are arranged like a matrix.

One pixel thin-film transistor TFT, storage capacitor Cs, and pixel electrode Ep are set to each pixel 2. Either of the source and drain of the pixel thin-film transistor TFT is connected to the data lines D and the other of them is connected to one-hand electrode of the storage capacitor Cs and the pixel electrode Ep, the gate of the transistor TFT is connected to the gate lines G. Moreover, the ground potential is applied to the other-hand electrode of the storage capacitor Cs. Furthermore, a common electrode Eo is set to a position corresponding to each pixel on the opposite-side glass substrate and a pixel capacitor Clc is formed between the pixel electrode Ep and the common electrode Eo. In this invention, the other-hand electrode of the storage capacitor is applied the ground potential, however, the other-hand electrode of the storage capacitor is applied some potential other than the ground potential.

Furthermore, data driver circuitry 3 for driving the data lines D and gate driver circuitry 4 for driving the gate lines G are formed at the outside of a region in which a plurality of pixels 2 are formed on the TFT-side glass substrate. Data-line driving circuitry 5 and analog switches (ASWs) SW1-1 to SW3-3 (hereafter also generally referred to as ASWs) are set to the data driver circuitry 3. Output terminals of the data-line driving circuitry 5 are connected to video signal lines V1 to V3. The data-line driving circuitry 5 outputs video signals to the video signal lines V1 to V3.

Moreover, a plurality of data lines, for example, three data lines D adjacent to each other form one block (group). For example, the data lines D1 to D3 belong to a first group, the data lines D4 to D6 belong to a second group, and the data lines D7 to D9 belong to a third group. Furthermore, the data-line driving circuitry 5 is provided with the total of three output terminals respectively assigned to each group of the above data lines and the three output terminals are connected to the video signal lines V1 to V3.

Furthermore, each video signal line is connected to each data line D through an ASW. Specifically, the video signal line V1 is connected to the data lines D1 to D3 through the switches SW1-1 to SW1-3, the video signal line V2 is connected to the data lines D4 to D6 through the switches SW2-1 to SW2-3, and the video signal line V3 is connected to the data lines D7 to D9 through the switches SW3-1 to SW3-3.

When generally showing the above description, n data lines D (three lines for this embodiment) belong to each group in the case of the data-line driving circuitry 5 and the k-th (k is an integer of 1 to n) switch for switching whether to connect the k-th data line D in each group to a video signal line is set. The number of the k-th switches is the same as the number of groups and is, for example, 3. That is, when assuming the number of groups as m, the number of output terminals, the number of video signal lines, and the number of k-th switches are respectively m and the total number of switches is the same as the number of data lines D, for example, 9.

Moreover, the total of n k-th control lines connected to the k-th switch in each group in common is set to the data-line driving circuitry 5. For example, in the case of this embodiment, three control lines SP1 to SP3 are set. Furthermore, the control line SP1 is connected to the switches SW1-1, SW2-1, and SW3-1, the control line SP2 is connected to the switches SW1-2, SW2-2, and SW3-2, and the control line SP3 is connected to the switches SW1-3, SW2-3, and SW3-3. Furthermore, driving circuitry 6 is set to the data-line driving circuitry 5 and the control lines SP1 to SP3 are connected to output terminals of the driving circuitry 6.

The switches SW1-1 to SW3-3 are respectively constituted of, for example, a thin-film transistor (TFT), the data-line driving circuitry 5 is connected to one of the source and drain of each TFT, the data lines D are connected to the other of them, and the control lines SP1 to SP3 are connected to the gate of the transistor. Thereby, for example, when the potential of the control line SP1 becomes high level, the switches SW1-1, SW2-1, and SW3-1 are turned on and the video signal line V1, V2 and V3 are respectively connected to the data lines D1, D4 and D7. When the potential of the control line SP1 becomes low level, the switches SW1-1, SW2-1, and SW3-1 are turned off and the data lines D1,D4 and D7 respectively become a floating state.

This embodiment shows an example in which the number of data lines is 9, the number of gate lines is 6, and three adjacent data lines belong to one group and are connected to one output terminal of the data-line driving circuitry 5 via a ASW. However, the present invention is not restricted to the above example. The number of data lines, the number of gate lines, and the number of data lines belonging to one group do not influence the essence of the present invention.

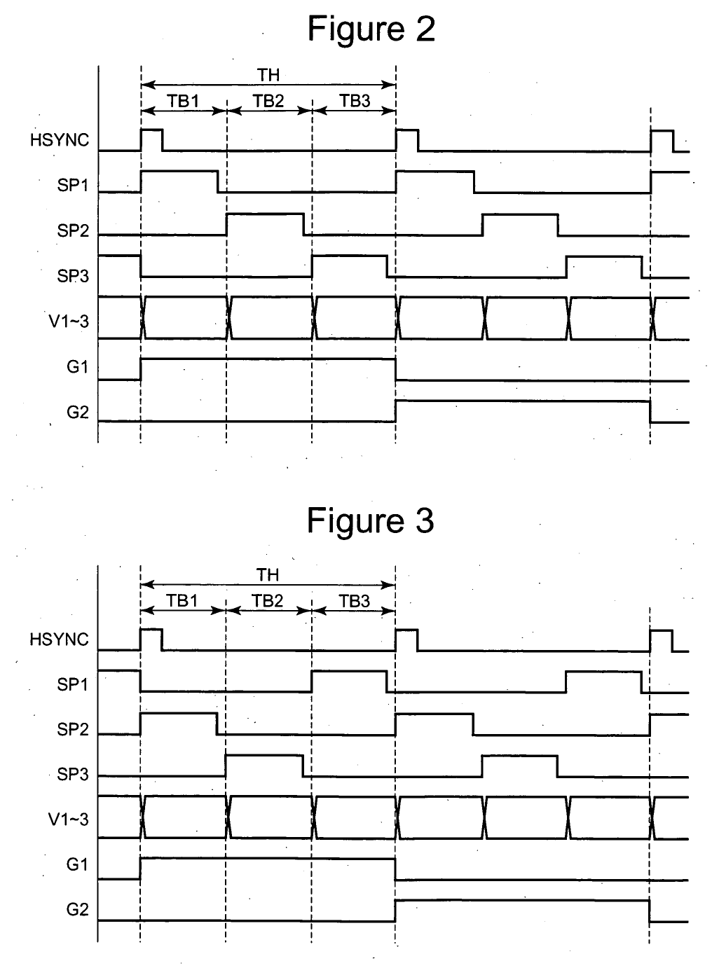

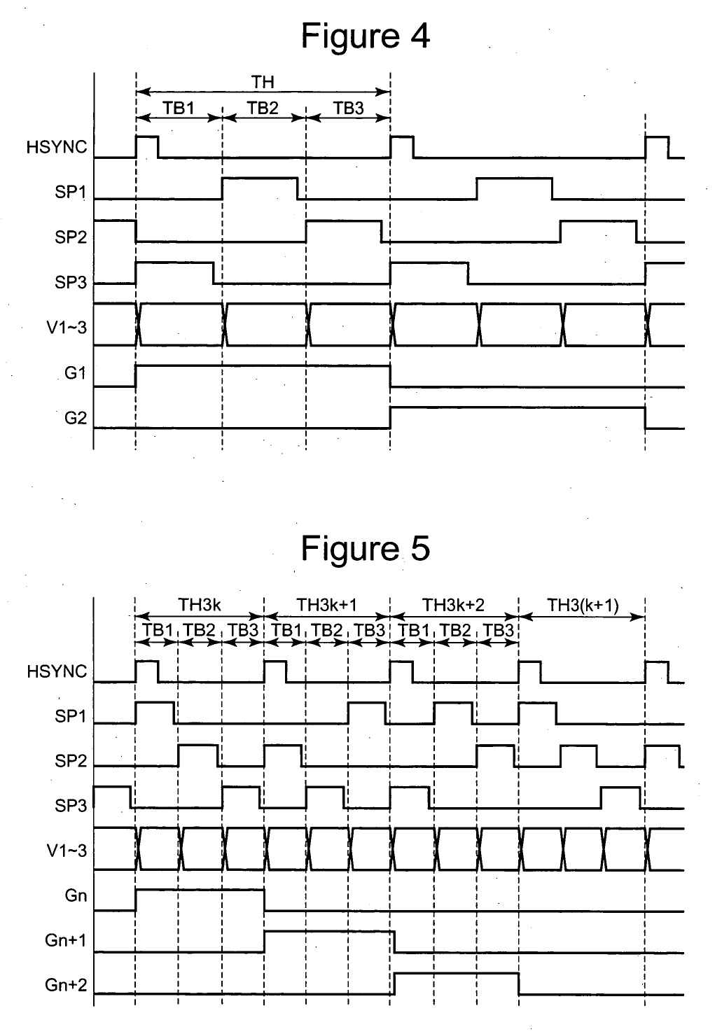

Then, operations of the liquid-crystal display of this embodiment constituted as described above, that is, a driving method of the liquid-crystal display of this embodiment are described below. FIGS. 2 to 4 are timing charts showing operations of the liquid-crystal display of this embodiment by allocating time to the axis of abscissa and potential of each wiring to the axis of ordinate, in which FIG. 2 shows operations in a certain vertical period, FIG. 3 shows operations in a vertical period next to the vertical period shown in FIG. 2, and FIG. 4 shows operations in a vertical period next to the vertical period shown in FIG. 3.

In the case of this embodiment, the gate driver circuitry 4 successively selects all gate lines G and the data driver circuitry 3 outputs video signals to all data lines D and thereby, a vertical period for displaying images for one screen on a screen constituted of a plurality of pixels 2 is repeatedly executed. Moreover, in each vertical period, a horizontal period for outputting video signals for one pixel row to the data lines D while one gate line G is selected is successively executed for all gate lines G.

The period TH shown in FIG. 2 shows one horizontal period in which one gate line G1 is selected by the gate driver circuitry 4 and video signals are written in one pixel row connected to the one gate line G1. Moreover, in periods TB1 to TB3 obtained by dividing the one horizontal period into three equal periods, the driving circuitry 6 sets the potential of any one of the control lines SP1 to SP3 for controlling ASWs to a potential for turning on an ASW, for example, a high-level potential. Namely, pulses are applied to the control lines SP1 to SP3. In the vertical period shown in FIG. 2, pulses are applied to the control line SP1 in the period TB1, pulses are applied to the control line SP2 in the period TB2, and pulses are applied to the control line SP3 in the period TB3. Thereby, the switches SW1-1, SW2-1, and SW3-1 are turned on in the period TB1 and the data lines D1, D4, and D7 are connected to the video signal lines V1, V2, and V3. Moreover, in the period TB2, the switches SW1-2, SW2-2, and SW3-2 are turned on and the data lines D2, D5, and D8 are connected to the video signal lines V1, V2, and V3. Furthermore, in the period TB3, the switches SW1-3, SW2-3, and SW3-3 are turned on and the data lines D3, D6, and D9 are connected to the video signal lines V1, V2, and V3. In this embodiment, one horizontal period is divided into three equal periods, however, three divided periods do not need to be equal.

The data-line driving circuitry 5 outputs signals to be written in the pixel at the intersection between the data line D1 and the gate line G1 (hereafter referred to as pixels (D1 and G1)) to the video signal line V1 in the period TB1 and outputs signals to be written in the pixel (D4 and G1) to the video signal line V2 and signals to be written in the pixel (D7 and G1) to the video signal line V3. Similarly in the period TB2, the circuitry 5 outputs signals to be written in the pixels (D2 and G1), pixels (D5 and G1), and pixels (D8 and G1) to the video signal lines V1, V2, and V3. In the period TB3, the circuitry 5 outputs signals to be written in the pixels (D3 and G1), pixels (D6 and G1), and pixels (D9 and G1) to the video signal lines V1, V2, and V3.

In this case, because pulses at a voltage for turning on a pixel TFT are applied to the gate line G1 in this horizontal period, a video signal voltage held by a data line is written in each pixel connected to the gate line G1. That is, a pixel thin-film transistor TFT connected to the gate line G1 is turned on and the data lines D are connected to the pixel electrode Ep and one electrode of the storage capacitor Cs through the pixel thin-film transistor TFT and charges corresponding to video signals are accumulated in the pixel capacitor Clc and storage capacitor Cs, the liquid-crystal layer between the pixel electrode Ep and the common electrode Eo is oriented to form a part of an image. Moreover, by applying operations in the above horizontal period to all gate lines, it is possible to write video signals for one screen in all pixels 2 and display one screen by the whole screen.

Then, as shown in FIG. 3, in a vertical period continued from the vertical period shown in FIG. 2, pulses are applied to the control line SP2 in the period TB1, the switches SW1-2, SW2-2, and SW3-2 are turned on, video signals are written in the data lines D2, D5, and D8. Pulses are applied to the control line SP3 in the period TB2, the switches SW1-3, SW2-3 and SW3-3 are turned on, video signals are written in the data lines D3, D6 and D9. Pulses are applied to the control line SP1 in the period TB3, the switches SW1-1, SW2-1, and SW3-1 are turned on, and video signals are written in the data lines D1, D4, and D7.

Then, as shown in FIG. 4, in a vertical period continued from the vertical period shown in FIG. 3, pulses are applied to the control line SP3 in the period TB1, the video signals are written in the data lines D3, D6 and D9, pulses are applied to the control line SP1 in the period TB2, video signals are written in the data lines D1, D4, and D7, pulses are applied to the control line SP2 in the period TB3, and video signals are written in the data lines D2, D5, and D8.

In the vertical periods shown in FIGS. 3 and 4, the sequence for writing a video signal in a data line in one horizontal period is only different from the case of the vertical period in FIG. 2 but operations other than that is the same as the operations in the vertical period in FIG. 2 and video signals for one screen are displayed. An operation is realized in which an order that data-line driving circuitry writes data in each data line in time division is changed for every three continuous vertical periods in accordance with the above operation. That is, there are three types of sequences each of which outputs a video signal to a data line and the three types of sequences are repeatedly executed for every cycle constituted of three continuous vertical periods.

Then, advantages of this embodiment are described below. According to this embodiment, it is possible to greatly decrease the number of streak-like luminance irregularities along a data line. The reason is described below. As described above, in the case of the driving method for successively writing a signal in a data line in time division, streak-like irregularity is caused because the fluctuation of a potential generated through a parasitic capacitance when writing a signal in other data line differs between data lines by depending on a sequence for writing a signal. However, according to this embodiment, because a sequence for writing a signal in a data line in one horizontal period for every vertical period is changed, it is possible to prevent a large potential fluctuation from always occurring in the same data line and decrease the number of streak-like irregularities.

Moreover, because a cycle in which the sequence is changed makes circuitry in three vertical periods equal to the number of data lines to be driven by one output of data-line driving circuitry and thereby, the potential fluctuation of a data line is uniformed in each data line, a luminance difference generated as a result is uniformed and it is not recognized as streak-like irregularity.

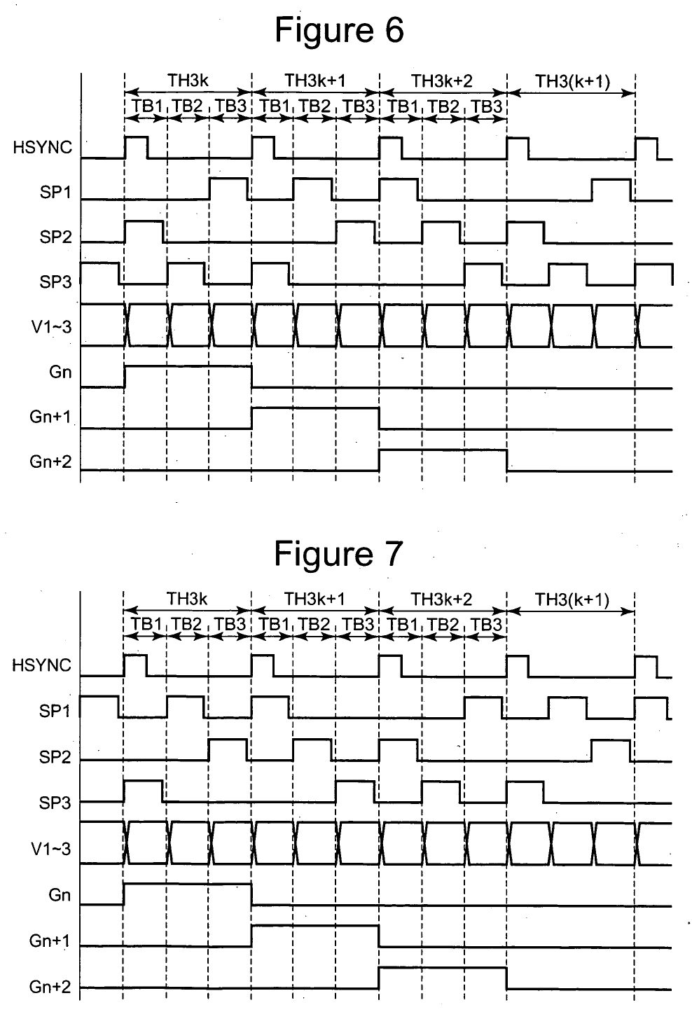

Then, second embodiment of the present invention is described. FIGS. 5 to 7 are timing charts showing operations of a liquid-crystal display of this embodiment by assigning time to the axis of abscissa and potential of each wiring to the axis of ordinate, in which FIG. 5 shows operations in a plurality of continuous horizontal periods in a certain vertical period, FIG. 6 shows operations in a plurality of continuous horizontal periods in a vertical period next to the vertical period shown in FIG. 5, and FIG. 7 shows operations in a plurality of continuous horizontal periods in a vertical period next to the vertical period shown in FIG. 6. A configuration of the liquid-crystal display of this embodiment is the same as that of the above-described first embodiment but only a signal generation sequence of driving circuitry 6 is different from the case of the above-described first embodiment.

The periods TH3k, TH3k+1, TH3k+2, and TH3(k+1) shown in FIG. 5 respectively show a horizontal period and each horizontal period is divided into three periods TB1, TB2, and TB3 which are almost divided into three equal periods. In the period TB1 of the horizontal period TH3k, pulses at a potential at which an ASW is turned on are applied to a control line SP1 to write video signals in data lines D1, D4, and D7. Moreover, in the period TB2, pulses are applied to a control line SP2 to write video signals in data lines D2, D5, and D8. Furthermore, in the period TB3, pulses are applied to a control line SP3 to write video signals in data lines D3, D6, and D9. In the next horizontal period TH3k+1, the video signals are written in the data lines D2, D5 and D8 in the period TB1, the video signals are written in the data lines D3, D6 and D9 in the period TB2 and the video signal are written in the data lines D1, D4 and D7 in the period TB3. Thus, in the vertical period shown in FIG. 5, a sequence for writing a signal in a data line is differentiated for every horizontal period.

Then, in the case of the vertical period shown in FIG. 6, video signals are written in the data lines D2, D5, and D8 in the period TB1, video signals are written in the data lines D3, D6, and D9 in the period TB2, and video signal are written in the data lines D1, D4, and D7 in the period TB3 in the horizontal period TH3k. Then, data lines in which signals will be written for every three divided periods are changed also in the periods T3k+1 and T3k+2. Moreover, in the vertical period shown in FIG. 7 continued from the above vertical period, video signals are written in the data lines D3, D6, and D9 in the period TB1, video signals are written in the data lines D1, D4, and D7 in the period TB2, and video signals are written in the data lines D2, D5, and D8 in the period TB3 in the horizontal period T3k. Then, also in the continued horizontal periods T3k+1 and T3k+2, data lines in which signals are written for every three divided periods are changed. That is, in the case of this operation, a sequence for writing a signal in a data line is changed for every three continued horizontal periods and the sequence is counterchanged in three continuous vertical periods.

In the case of this embodiment, by performing the above operations, a sequence for writing a signal in a data line is changed for every continuous vertical period and it is also changed for every horizontal period in the same vertical period. Thereby, because a data line which receives much potential fluctuation due to a parasitic capacitance with an adjacent data line is changed at a cycle in which a horizontal period is repeated, a person cannot easily recognize a luminance difference between pixels due to potential fluctuation. As a result, it is possible to make it more difficult that streak-like irregularity is recognized compared with the case of the above first embodiment.

In the case of this embodiment, a sequence for writing a signal in a data line is changed for every continuous vertical period. However, it doesn't require to change for every continuous vertical period, if the sequence is changed for every horizontal period in the same vertical period.

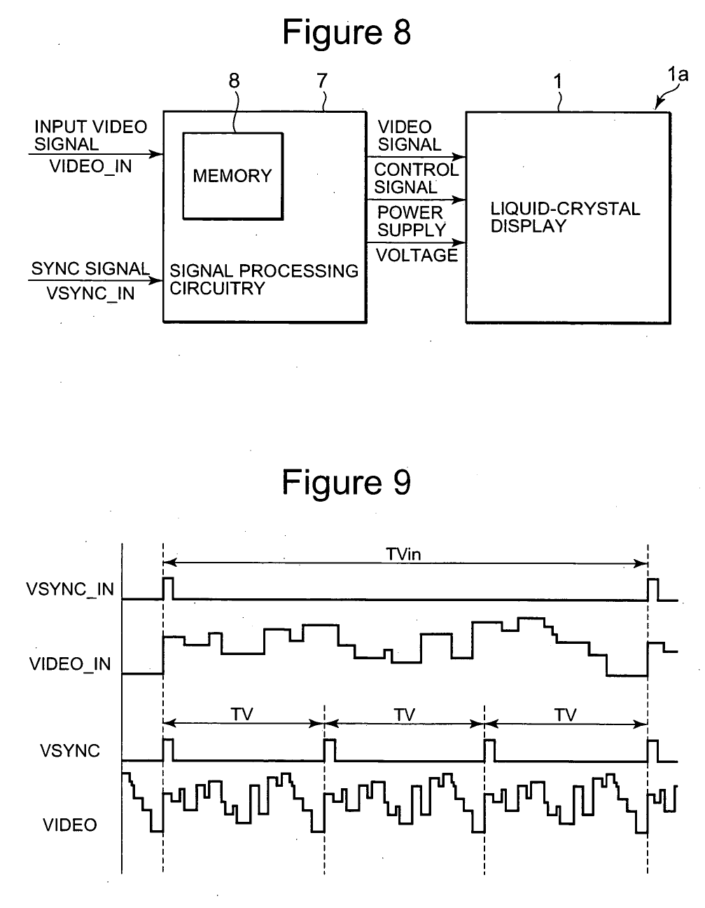

Then, third embodiment of the present invention is described below. FIG. 8 is a block diagram showing a liquid-crystal display of this embodiment. As shown in FIG. 8, in the case of the liquid-crystal display 1a of this embodiment, signal processing circuitry 7 is set to the liquid-crystal display 1 of the above first embodiment. The signal processing circuitry 7 generates a video signal and a control signal to be supplied to the liquid-crystal display 1 from a video signal and a sync signal input from the outside and supplies these signals to the liquid-crystal display 1 together with a power-supply voltage. The signal processing circuitry 7 is provided with a memory 8 capable of holding video signals to be displayed on the liquid-crystal display 1 for at least one screen or preferably for two screens.

Then, operations of the liquid-crystal display of this embodiment constituted as described above, that is, a driving method of the liquid-crystal display of this embodiment are described below. FIG. 9 is a timing chart showing operations of the liquid-crystal display of this embodiment by assigning time to the axis of abscissa and potential of each wiring to the axis of ordinate. In FIG. 9, signals VSYNC_IN and VIDEO_IN show a vertical sync signal of a video signal and a video signal supplied to the signal processing circuitry 7 from a signal source and signals VSYNC and VIDEO show a vertical sync signal and video signal supplied to the liquid-crystal display 1.

Video signals for one screen are supplied to the signal processing circuitry 7 for every vertical period TVin and the memory 8 temporarily stores the video signals. Then, the signal processing circuitry 7 compresses the time width of the video signals for one screen stored in the memory 8 to, for example, (⅓) times. Then, the signal processing circuitry 7 outputs the compressed video signals to the liquid-crystal display 1 at a frequency three times higher than a frequency supplied from a signal source. Then, the liquid-crystal display 1 displays an image by the operation same as the case of the above-described first embodiment in accordance with a video signal input at the three-time-high frequency. Therefore, the vertical period TV of a video signal to be supplied to the liquid-crystal display 1 has a length ⅓ the vertical period TVin of a video signal to be supplied to the signal processing circuitry 7.

Thus, this embodiment displays the same video signal a plurality of times in one vertical period of a video signal supplied from a signal source. Moreover, it is preferable that the number of times for displaying the same video signal is equal to the number of data lines (three lines for this embodiment) to be driven by one output of the data driving circuitry in the liquid-crystal display in time division.

Then, advantages of this embodiment are described below. In the case of this embodiment, it is possible to further shorten a cycle for changing a writing sequence in a data line compared with the above described first and second embodiment. Thereby, it is possible to make it more difficult that streak-like irregularity is recognized. As a result, it is possible to almost completely prevent streak-like irregularity from being recognized.

Moreover, by equalizing the number of times for displaying the same video signal in one vertical period of an external signal with the number of data lines to be connected to one output terminal of data driving circuitry, that is, the number of data lines belonging to one group, it is possible to almost equalize potential fluctuations generated in all data lines in one vertical period of a video signal input to the signal processing circuitry 7 from a signal source. Therefore, it is possible to make it more difficult that the luminance difference between pixels due to potential fluctuation is recognized.

In the case of this embodiment, an example is shown in which a video signal supplied to the signal processing circuitry 7 from a signal source is an analog signal and a video signal supplied to the liquid-crystal display 1 from the signal processing circuitry 7 is also an analog signal. Even if these video signals are received as digital signals, there is no problem. Moreover, in this embodiment, though an example is shown in which operations of the liquid-crystal display 1 are the same as the case of the above-described first embodiment, it is allowed to make the operations same as the case of the above-described second embodiment.

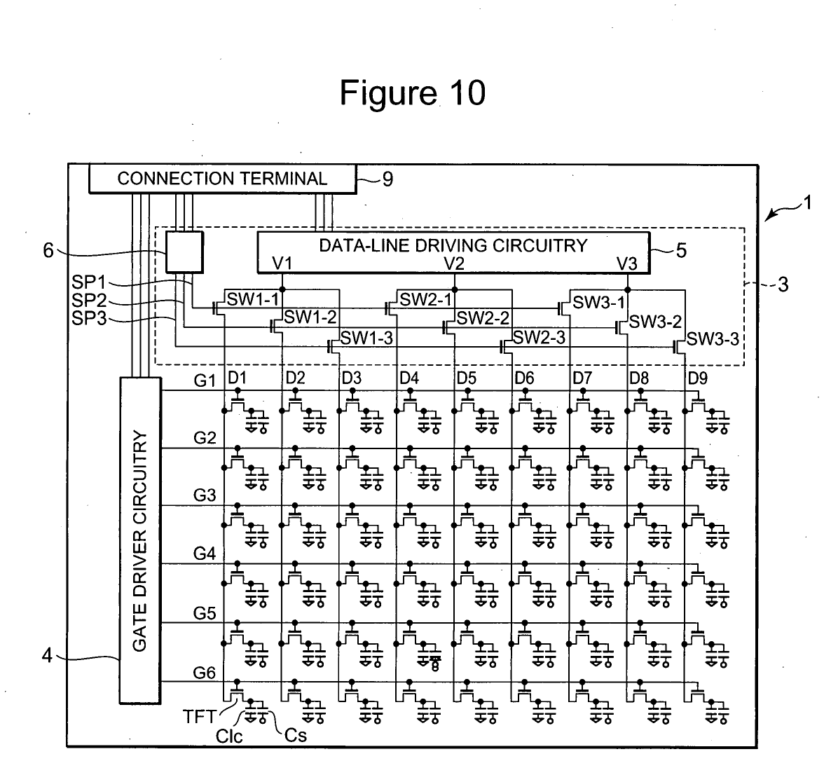

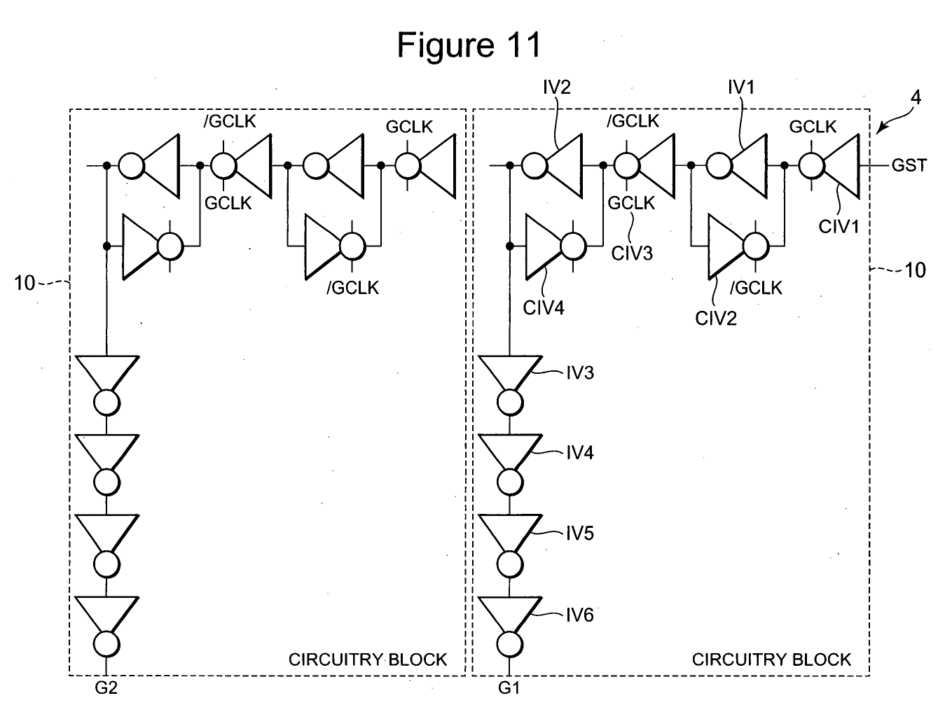

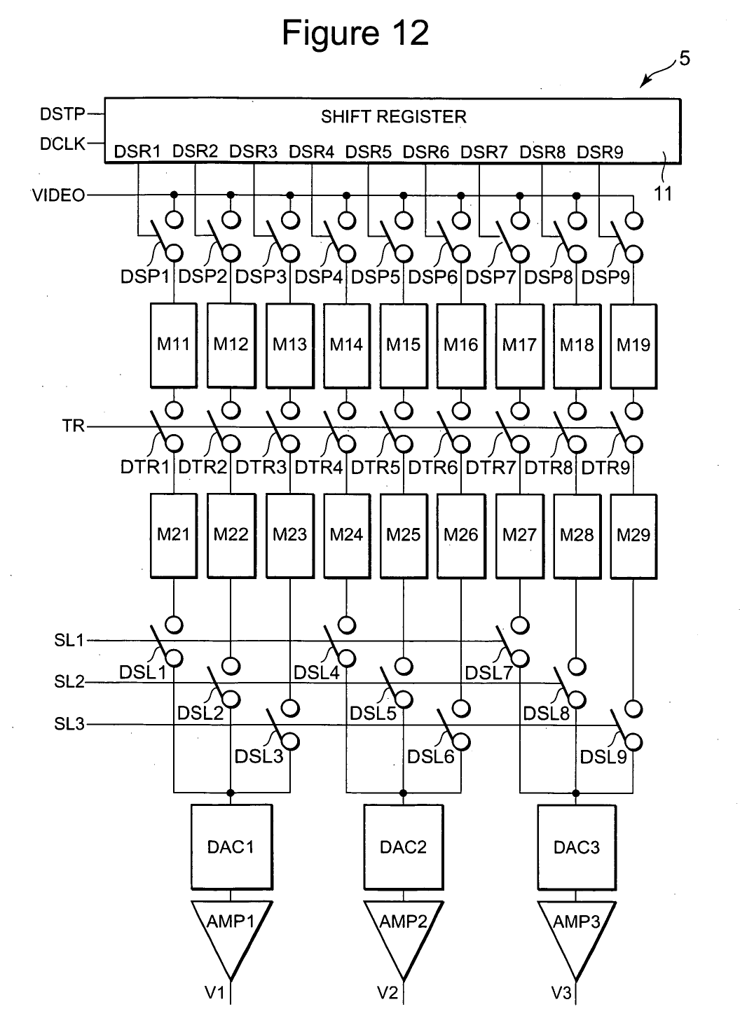

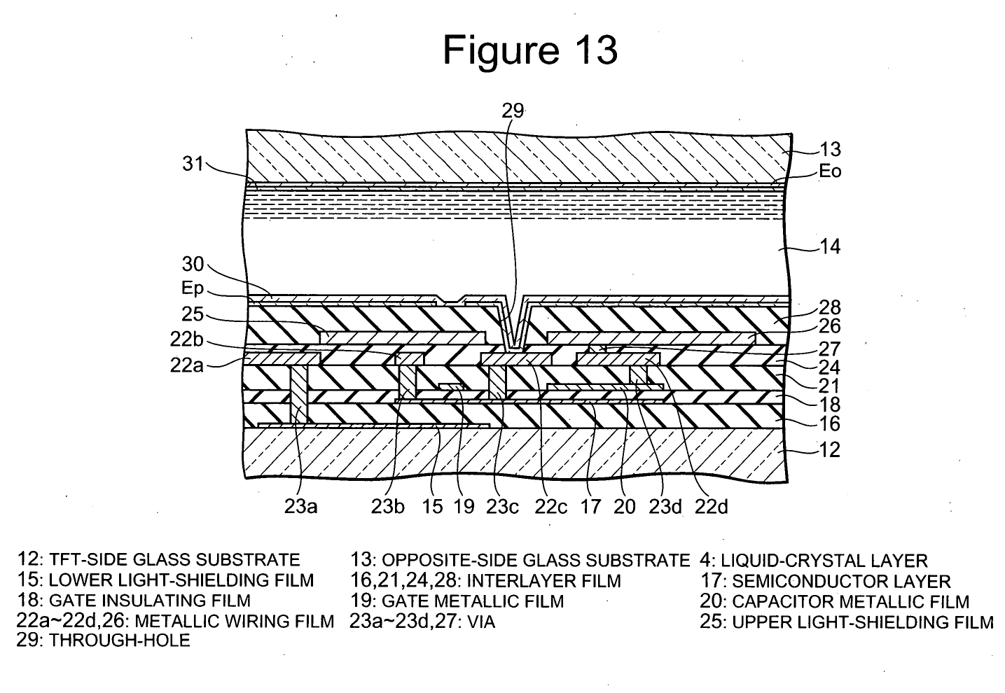

Then, fourth embodiment of the present invention is described. FIG. 10 is a block diagram showing a liquid-crystal display of this embodiment. FIG. 11 is circuitry diagram showing gate driver circuitry of this embodiment, FIG. 12 is a block diagram showing a data-line driving circuitry of this embodiment, and FIG. 13 is sectional view showing the liquid-crystal display of this embodiment. The fourth embodiment describes the above-described first embodiment more minutely.

As shown in FIG. 10, in the case of the liquid-crystal display of this embodiment, a connection terminal 9 for inputting a signal from the outside is set on a TFT-side glass substrate 12 (refer to FIG. 13). Data driver circuitry 3, gate driver circuitry 4, and common electrode set on an opposite-side glass substrate 13 (refer to FIG. 13) are connected to the connection terminal 9. Moreover, signals to be supplied to the data-line driving circuitry 5 and driving circuitry 6 of the data driver circuitry 3, gate driver circuitry 4, and common electrode are supplied from the outside through the connection terminal 9. In general, an Flexible Printed Circuitry (FPC) is used for the above connection.

As shown in FIG. 11, the gate driver circuitry 4 is constituted of buffer circuitry using inverter and a static shift register constituted of a CMOS. That is, in the case of the gate driver circuitry 4, a plurality of circuit blocks 10 are connected at a plurality of stages in series. Moreover, a start signal GST is input to the first-stage circuitry block 10 and an output signal of the previous-stage circuitry block is input to circuit blocks 10 downward from the second-stage circuit block 10. In FIG. 11, only the first- and second-stage circuit blocks 10 are illustrated.

A clocked inverter CIV1 to which the start signal GST or an output signal of the circuit block 10 at the previous stage is input is set to the input node of the circuit block 10 at each stage. Moreover, an inverter IV1 whose input node is connected to the output node of the clocked inverter CIV1 is set and a clocked inverter IV2 whose input node is connected to the output node of the inverter IV1 and whose output node is connected to the input node of the inverter IV1 is set. Furthermore, a clocked inverter CIV3 whose input node is connected to the output node of the inverter IV1 is set, an inverter IV2 whose input node is connected to the output node of the clocked inverter CIV3 is set and a clocked inverter IV4 whose input node is connected to the output node of the inverter IV2 and whose output node is connected to the input node of the inverter IV2 is set. Furthermore, the output node of the inverter IV2 serves as the output node of the circuit block 10 and connected to the input node of the clocked inverter CIV1 of the circuit block 10 at the next stage. Furthermore, inverters IV3 to IV6 are connected in order in series, the input node of the inverter IV3 is connected to the output node of the inverter IV2 and the output node of the inverter IV6 is connected to a gate line G. That is, the output node of the inverter IV6 of the circuit block 10 at the first stage is connected to the gate line G1 and the output node of the inverter IV6 of the circuit block 10 at the k-th stage is connected to the gate line Gk. A clocked inverter is controlled by two clock signals GCLK and /GCLK whose phases are different from each other.

The data-line driving circuitry 5 samples a video signal supplied from the outside and digital-analog-converts and outputs the video signal. Moreover, the circuitry 5 selects and outputs any one of signals held in the inside. The data-line driving circuitry 5 is COG-connected onto the TFT-side glass substrate 12 (refer to FIG. 13). In this case, what number of data lines is driven by one output of the data-line driving circuitry 5 is frequently decided by a terminal pitch and a pixel pitch when performing COG connection. At present, the minimum terminal pitch of COG connection is approx. 60 μm and the resolution of a liquid-crystal display used for a projector is a length of 1024 and width of 768. Therefore, When a display diagonal is 1″ (approx. 25.4 mm), the pixel pitch becomes approx. 20 μm. Therefore, when one output of data-line driving circuitry drives three data lines, it is possible to decrease a region of a wiring connecting the data-line driving circuitry with a data line and this is advantageous in downsizing a liquid-crystal display.

As shown in FIG. 12, the data-line driving circuitry is provided with a shift register 11. A start signal DSTP and clock signal DCLK are input to the shift register 11 and the circuitry 5 successively outputs signals from nine output terminals DSR1 to DSR9. Moreover, data sampling switches DSP1 to DSP9 in which turning-on/turning-off is selected by signals output from output terminals DSR1 to DSR9 are set to the data-line driving circuitry 5 and a video signal VIDEO is applied to one ends of the data sampling switches DSP1 to DSP9 from the outside through the connection terminal 9 (refer to FIG. 10).

Moreover, memories MI11 to M19 are connected to the other ends of the data sampling switches DSP1 to DSP9. The memories M11 to M19 constitute a first memory group. The first memory group samples a video signal supplied from the outside in accordance with an output of the shift register 11. Moreover, data transfer switches DTR1 to DTR9 are connected to the memories M11 to M19. These data transfer switches DTR1 to DTR9 select turning-on/turning-off by a common control signal TR. The data transfer switches DTR1 to DTR9 simultaneously transfer signals held by the first memory group.

Furthermore, memories M21 to M29 are connected to the other ends of the data transfer switches DTR1 to DTR9. The memories M21 to M29 constitute a second memory group. The second memory group holds video signals transferred from the first memory group. The memories M21 to M29 are connected to one ends of data selection switches DSL1 to DSL9. The other ends of the data selection switches DSL1 to DSL3 are connected to DAC circuitry DAC1 for digital-analog-converting the contents of the second memory, the other ends of the data selection switches DSL4 to DSL6 are connected to DAC circuitry DAC2, and the other ends of the data selection switches DSL7 to DSL9 are connected to DAC circuitry DAC3.

Furthermore, turning-on/turning-off of the data selection switches DSL1, DSL4, and DSL7 is selected by a common control signal SL1, turning-on/turning-off of the data selection switches DSL2, DSL5, and DSL8 is selected by a common control signal SL2, and turning-on/turning-off of the data selection switches DSL3, DSL6, and DSL9 is selected by a common control signal SL3.

Furthermore, amplifiers AMP1 to AMP3 for amplifying an output of DAC circuitry are set to the data-line driving circuitry 5 and input terminals of the amplifiers AMP1 to AMP3 are connected to the DAC circuitry DAC1 to DAC3, and output terminals of the amplifiers AMP1 to AMP3 are connected to video signal lines V1 to V3.

As shown in FIG. 13, the liquid-crystal display 1 of this embodiment is provided with a TFT-side glass substrate 12 and an opposite-side glass substrate 13 which are arranged in parallel to each other. Moreover, a liquid-crystal layer 14 is formed between the TFT-side glass substrate 12 and the opposite-side glass substrate 13.

A lower light-shielding film 15 made of WSi is formed on a part of the TFT-side glass substrate 12 and an interlayer film 16 made of SiO₂ is formed on the entire surface of the TFT-side glass substrate 12 so as to embed the lower light-shielding film 15. A semiconductor layer 17 made of P—Si (polysilicon) doped with an impurity is formed on a part of the interlayer film 16. The semiconductor layer 17 serves as the source region, channel region, and drain region of a TFT and one-hand electrode of the storage capacitor Cs. Moreover, a gate insulating film 18 made of SiO₂ is formed on the entire surface of the interlayer film 16 so as to embed the semiconductor layer 17. A gate metallic film 19 made of WSi is formed on a part of a region immediately above the semiconductor layer 17 on the gate insulating film 18. A region immediately below the gate metallic film 19 on the semiconductor layer 17 serves as the channel region of a TFT and regions at the both sides of the film 19 serve as a source and drain regions. Moreover, the gate metallic film 19 is connected to the gate lines G (refer to FIG. 10). Moreover, a capacitor metallic film 20 made of WSi is formed on the same layer as the gate metallic film 19. The capacitor metallic film 20 serves as the other-hand electrode of the storage capacitor Cs.

Then, an interlayer film 21 made of SiN is formed on the entire surface of the gate insulating film 18 so as to embed the gate metallic film 19 and capacitor metallic film 20 and first-layer metallic wiring films 22a to 22d made of Al are formed on a part of the interlayer film 21. The metallic wiring film 22a is connected to the lower light-shielding film 15 through a via 23a penetrating the interlayer film 21, gate insulating film 18, and interlayer film 16. Moreover, the metallic wiring film 22a is connected to a predetermined potential wiring (not illustrated). The metallic wiring film 22b is connected to either of the source and drain regions of the semiconductor layer 17 through a via 23b penetrating the interlayer film 21 and gate insulating film 18. Furthermore, the metallic wiring film 22b is connected to data lines D (refer to FIG. 10). The metallic wiring film 22c is connected to the other of the source and drain regions of the semiconductor layer 17 through a via 23c penetrating the interlayer film 21 and gate insulating film 18. The metallic wiring film 22 disconnected to the capacitor metallic film 20 through a via 23d penetrating the interlayer film 21.

Moreover, an interlayer film 24 made of SiN is formed on the entire surface of the interlayer film 21 so as to embed the first-layer metallic wiring films 22a to 22d and an upper light-shielding film 25 made of Al is formed on a part of the inter layer film 24. Furthermore, a second-layer metallic wiring film 26 made of Al is formed on the same layer as the upper light-shielding film 25. The metallic wiring film 26 is connected to the metallic wiring film 22d through a via 27 penetrating the interlayer film 24. Furthermore, the metallic wiring film 26 is also connected to a ground potential wiring (not illustrated). An interlayer film 28 made of SiN is formed on the entire surface of the interlayer film 24 so as to embed the upper light-shielding film 25 and metallic wiring film 26.

Furthermore, a transparent pixel electrode Ep made of ITO (Indium tin oxide) is formed on a part of the interlayer film 28. The pixel electrode Ep is connected to the metallic wiring film 22c through a through-hole 29 formed on the interlayer films 28 and 26. Furthermore, an alignment film 30 is formed on the entire surfaces of the interlayer film 28 and pixel electrode Ep.

A common electrode Eo made of ITO is formed on the opposite-side glass substrate 13 and an alignment film 31 is formed on the common electrode Eo. Moreover, the liquid-crystal layer 14 is formed so as to contact with the alignment films 30 and 31. Configurations of this embodiment other than the above described are the same as those of the above-described first embodiment.

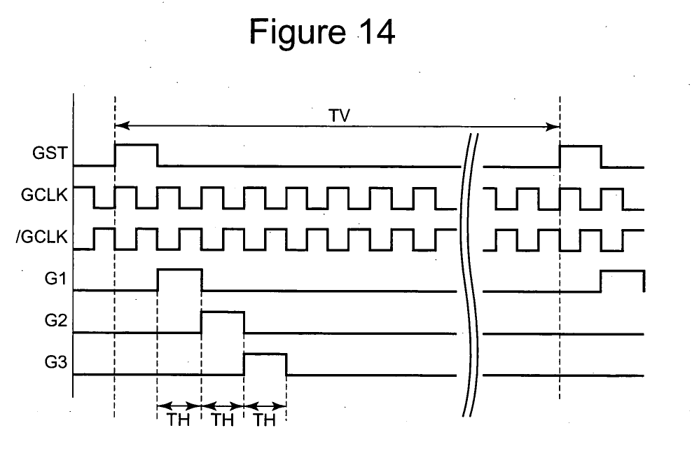

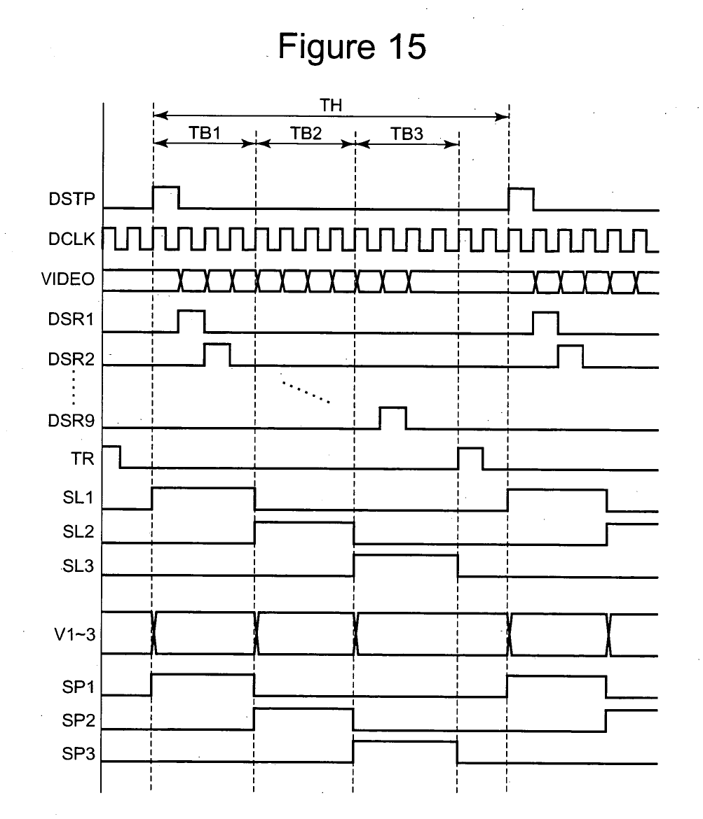

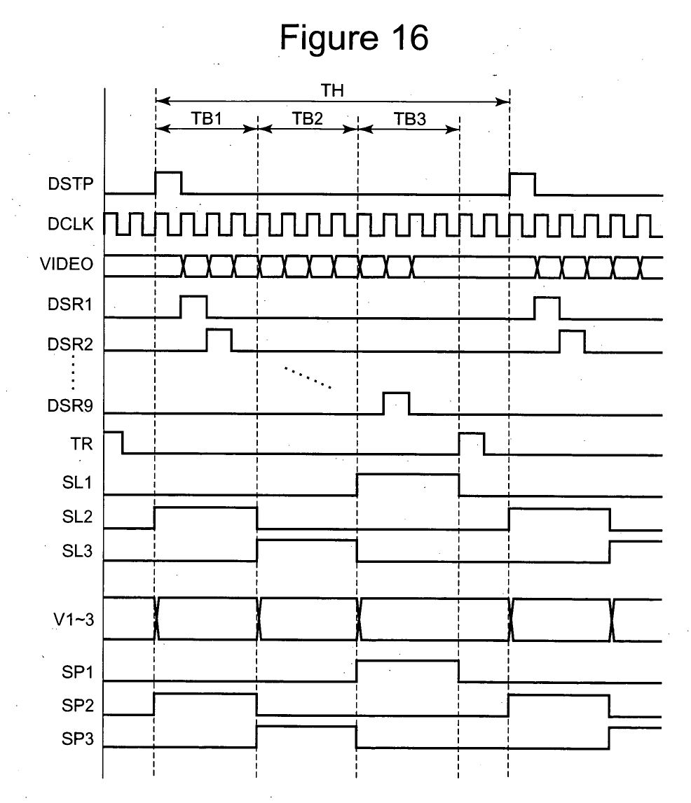

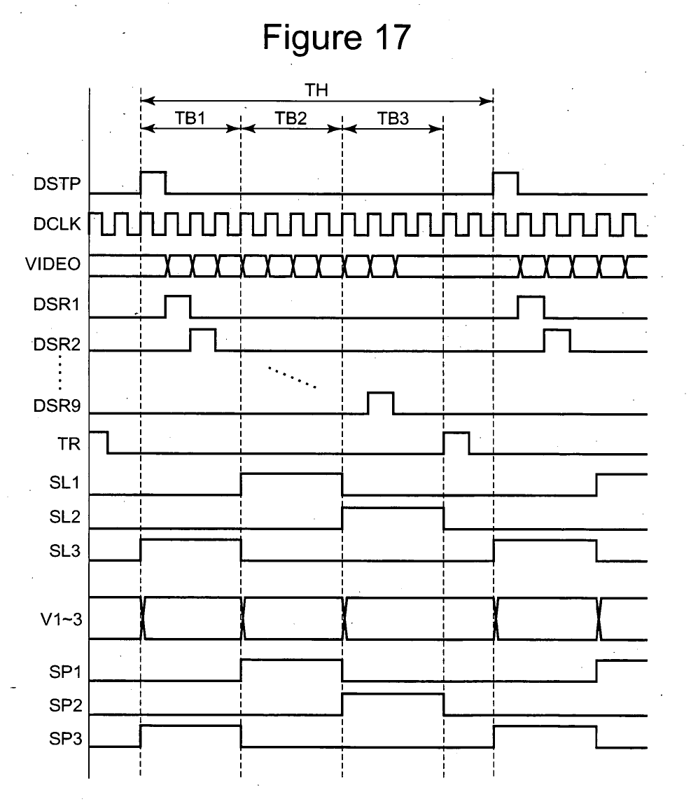

Then, operations of the liquid-crystal display of this embodiment constituted as described above, that is, a driving method of the liquid-crystal display of this embodiment are described below. FIG. 14 is a timing chart showing operations of gate driver circuitry of the liquid-crystal display of this embodiment by assigning time to the axis of abscissa and potential of each wiring to the axis of ordinate. FIGS. 15 to 17 are timing charts respectively showing operations of data driver circuitry of the liquid-crystal display of this embodiment by assigning time to the axis of abscissa and potential of each wiring to the axis of ordinate, in which FIG. 15 shows the operation in a certain vertical period, FIG. 16 shows the operation in a vertical period next to the vertical period in FIG. 15, and FIG. 17 shows the operation in a vertical period next to the vertical period in FIG. 16.

As shown in FIG. 14, the gate driver circuitry 4 is controlled by a start signal GST and two clock signals GCLK and /GCLK whose phases are different from each other. When the start signal GST synchronizing with a clock signal is supplied to the first-stage circuitry block 10 (refer to FIG. 11) of the gate driver circuitry 4, the gate driver circuitry 4 successively outputs a pulse having a length of one cycle of a clock synchronously with a clock signal. In this case, when equalizing the cycle of the clock signal GCLK with the cycle of the horizontal period of the liquid-crystal display, the gate driver circuitry 4 performs an operation for successively outputting a pulse to gate lines G for every horizontal period. That is, the start signal GST becomes high-level at the beginning of the vertical period TV shown in FIG. 14 and the gate lines G successively become high-level by using the fact that the start signal GST becomes high-level as a trigger. A period in which one gate line G is kept high-level is the horizontal period TH.

Moreover, as shown in FIG. 15, a start signal DSTP becomes high-level at the beginning of each horizontal period in an certain vertical period. Furthermore, the video signal VIDEO for displaying an image in the liquid-cristal display is successively supplied to the shift register 11 of the data driver circuitry 5 from the outside synchronously with the clock signal DCLK by using the start signal DSTP as a trigger. Then, the shift register 11 successively outputs pulses to the output terminals DSR1 to DSR9 synchronously with the clock signal DCLK and successively turns on the data sampling switches DSP1 to DSP9. Thereby, the first memory group (memories M11 to M19) successively samples and holds the supplied video signal VIDEO. After all signals are held by the first memory group, the data transfer switches DTR1 to DTR9 are simultaneously turned on by the control signal TR, signals held by the first memory group are simultaneously transferred to the second memory group (memories M21 to M29), and the second memory group holds the signals.

In the case of the held video signals, when the control signals SL1 to SL3 successively become high-level in the next horizontal period, the data selection switches DSL1, DSL4, and DSL7 are turned on in the period TB1, the data selection switches DSL2, DSL5, and DSL8 are turned on in the period TB2, and the data selection switches DSL3, DSL6, and DSL9 are turned on in the period TB3. Thereby, video signals held by the memories M21, M24, and M27 are output to the DAC circuitry DAC1 to DAC3 in the period TB1, digital-analog-converted by the DAC circuitry, amplified by the amplifiers AMP1 to AMP3, and output to the video signal lines V1 to V3. In this case, the signals output to the video signal lines V1 to V3 are written in the data lines D1, D4, and D7 in order to set the signal SP1 for the driving circuitry 6 (refer to FIG. 10) to control ASWs to a potential (high level) for turning on ASWs.

Similarly, video signals held by the memories M22, M25, and M28 are analog-converted, amplified, and output to the video signal lines V1 to V3 in the period TB2. Then, because the signal SP2 becomes high-level, the signals output to the video signal lines V1 to V3 are written in the data lines D2, D5, and D8. Moreover, in the period TB3, the video signals held by the memories M23, M26, and M29 are analog-converted, amplified, and output to the video signal lines V1 to V3. When the signal SP3 becomes high-level, the video signals are written in the data lines D3, D6, and D9.

As described above, because the gate driver circuitry 4 outputs a pulse for turning on a pixel thin-film transistor TFT to one gate line for every horizontal period, the signal written in data lines D are written in the pixel capacitor Clc and storage capacitor Cs. By applying this operation to all pixel rows, it is possible to display a two-dimensional image.

Moreover, as shown in FIG. 16, video signals are first written in the data lines D2, D5, and D8 in the period TB1 in one horizontal period in a vertical period next to the vertical period shown in FIG. 15 and then, video signals are written in the data lines D3, D6, and D9 in the period TB2, and finally signals are written in the data lines D1, D4, and D7 in the period TB3.

Furthermore, as shown in FIG. 17, in a vertical period next to the vertical period shown in FIG. 16, video signals are first written in the data lines D3, D6, and D9 in the period TB1 in one horizontal period, then video signals are written in the data lines D1, D4, and D7 in the period TB2, and finally video signals are written in the data lines D2, D5, and D8 in the period TB3.

The following advantage can be obtained from the liquid-crystal display of this embodiment. That is to greatly decrease the number of streak-like luminance irregularities along data lines. The reason is described below. Streak-like luminance irregularity is generated because a potential generated through a parasitic capacitance is different between data lines by depending on a sequence for writing a signal when writing a signal in another data line in driving for successively writing signals in data lines in time division in one horizontal period. However, in the case of the driving method of the liquid-crystal display of this embodiment, because a sequence for writing a signal in a data line in one horizontal period for every vertical period is changed. Therefore, a large potential fluctuation does not always occur in the same data line. Moreover, the cycle for the sequence to change makes circuitry in three vertical periods equal to the number of data lines to be driven by one output of data-line driving circuitry. Therefore, because potential fluctuations of data lines are uniformed in each data line, luminance differences generated as a result are also averaged and are not easily recognized as streak-like irregularity.

In the case of this embodiment, an example is shown in which each stage of the shift register in the gate driver circuitry 4 is constituted of four clocked inverters and two inverters. However, the present invention is not restricted to the above example. Even if a configuration other than the above is used, there is no problem as long as circuitry for successively outputting an output synchronously with a clock signal is used.

Furthermore, in the case of this embodiment, an example is shown in which the data driver circuitry 5 is constituted of the first memory group (memories M11 to M19), second memory group (memories M21 to M29), DAC circuitry DAC1 to DAC3 for digital-analog-converting the contents of the second memory group, amplifiers AMP1 to AMP3 for amplifying outputs of the DAC circuitry, and data selection switches DSL1 to DSL9 for connecting the second memory group with the DAC circuitry. However, the present invention is not restricted to the above example. Even if using a configuration other than the above, there is no problem as long as circuitry having the above function is used.

Furthermore, in the case of the liquid-crystal display of this embodiment, materials for forming a wiring metallic film, light-shielding metallic film, and interlayer film are not greatly related with the essence of the present invention. There is no problem even if using materials other than the above materials.

Furthermore, in the case of this embodiment, an example is shown in which the number of data lines is 9, the number of gate lines is 6, and the number of data lines connected to one output of data-line driving circuitry is 3. However, the present invention is not restricted to the above example. It is possible to optionally select these values in accordance with the specification of a required liquid-crystal display.

Furthermore, in the case of this embodiment, an example is shown in which gate driver circuitry is constituted by forming a pixel TFT on a TFT-side glass substrate on which pixels are arranged. However, it is also allowed to supply a signal for driving each gate line from the outside. However, it is preferable to fabricate a liquid-crystal display for a projector on the same substrate as pixels because it is necessary to minimize the size of the display.

Furthermore, in the case of this embodiment, an example is shown in which gate driver circuitry is set to only either side of a pixel matrix. However, it is also allowed to set the gate driver circuitry to the both sides of the pixel matrix. In this case, by driving one gate line from two directions by two gate driver circuitry arranged at the both sides, an advantage is obtained that the rise time and fall time of a pulse to be supplied to a gate line are shortened. Moreover, by driving different gate lines by the two gate driver circuitry arrange at the both sides, this is advantageous for decreasing a liquid-crystal display in size and improving the display in definition because it is possible to take a large pitch between output terminals in each gate driver circuitry.

Furthermore, it is also allowed to supply a signal and power-supply voltage necessary for the gate driver circuitry 4 and a power-supply voltage to be supplied to a common electrode from the data-line driving circuitry 5.

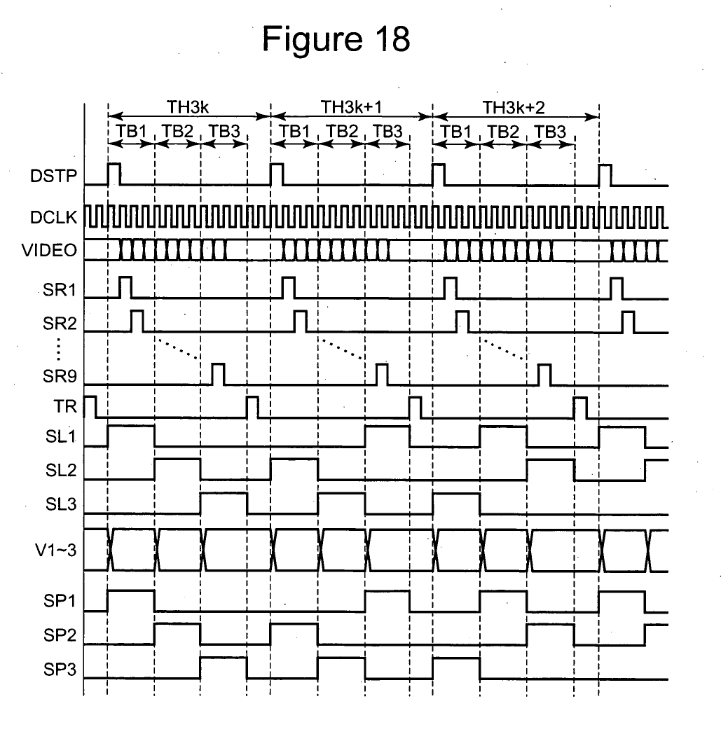

Then, fifth embodiment of the present invention is described below. This embodiment is described more minutely than the embodiment transformed the above-described second embodiment. Because a configuration of the liquid-crystal display of this embodiment is the same as the configuration of the liquid-crystal display of the above-described fourth embodiment, its description is omitted. Operations of the liquid-crystal display of this embodiment are described below. FIG. 18 is a timing chart showing operations of data driver circuitry of the liquid-crystal display of this embodiment by assigning time to the axis of abscissa and potential of each wiring to the axis of ordinate. As shown in FIG. 18, when the driving circuitry 6 (refer to FIG. 10) sets the potential of the control line SP1 to high level in the period TB1 in a certain horizontal period TH3k, video signals are written in the data lines D1, D4, and D7. Then, the potential of the control line SP2 becomes high-level in the period TB2 and video signals are written in the data lines D2, D5, and D8. Then, in the period TB3, the potential of the control line SP3 becomes high-level and video signals are written in the data lines D3, D6, and D7. Operations until a signal is written in data-line driving circuitry in a horizontal period and output are the same as the operations described for the above fourth embodiment.

In TH3k+1 which is the next horizontal period, video signals are written in the data lines D2, D5, and D8 in the period TB1, then video signals are written in the data lines D3, D6, and D9 in the period TB2, and video signals are written in the data lines D1, D4, and D7 in the period TB3. In the next horizontal period TH3k+2, video signals are written in the data lines D3, D6, and D9 in the period TB1, video signals are written in the data lines D1, D4, and D7 in the period TB2, and signals are written in the data lines D2, D5, and D8 in the period TB3. Thus, in the case of this embodiment, a sequence for writing a video signal in a data line is differentiated for every horizontal period.

In the case of the liquid-crystal display of this embodiment, the following advantage is obtained. It is an advantage that recognition of streak-like irregularity is made difficult. The reason why this advantage is obtained is that a data line for receiving much potential fluctuation of a data line is changed by the frequency in a horizontal period because a sequence for writing the signals in the data lines is changed for every continuous horizontal period and therefore, a person cannot easily recognize a luminance difference between pixels due to potential fluctuation.

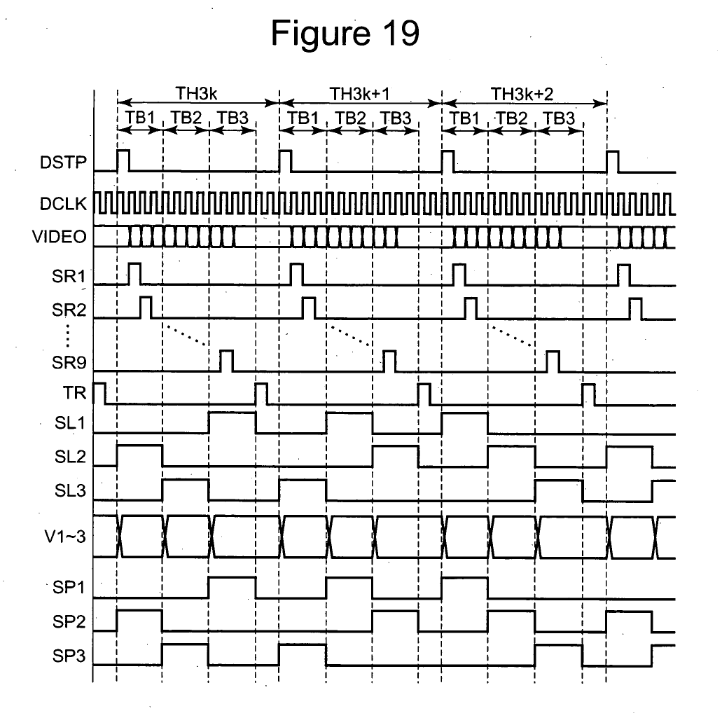

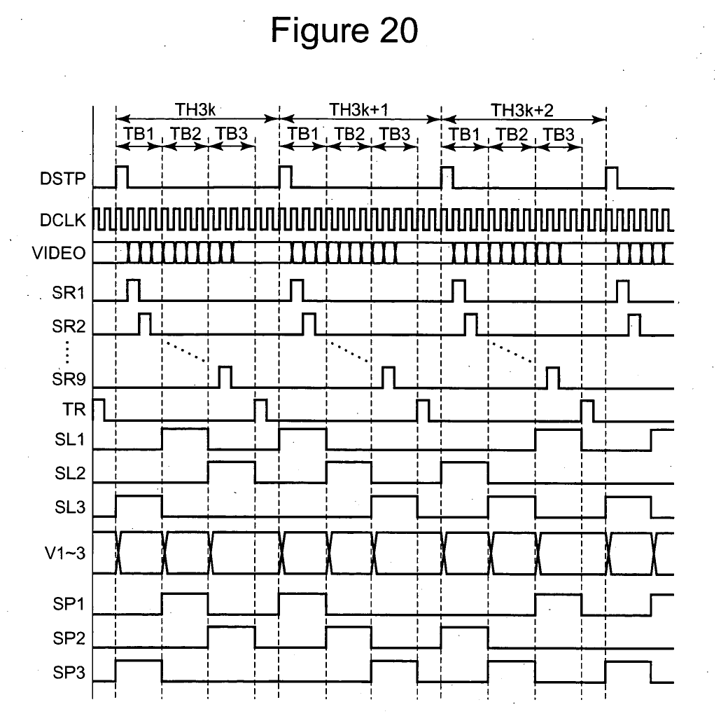

Then, sixth embodiment of the present invention is described below. Because a configuration of the liquid-crystal display of this embodiment is the same as the configuration of the liquid-crystal display of the fourth embodiment, its description is omitted. Operations of the liquid-crystal display of this embodiment are described below. This embodiment is obtained by further improving the driving method of the liquid-crystal display of the fifth embodiment. In the case of the driving method of the liquid-crystal display of this embodiment, an operation in a certain vertical period is the same as the operation shown in FIG. 18. Moreover, FIGS. 19 and 20 are timing charts respectively showing operations of data driver circuitry of the liquid-crystal display of this embodiment by assigning time to the axis of abscissa and potential of each wiring to the axis of ordinate, in which FIG. 19 shows the operation in a vertical period next to the vertical period shown in FIG. 18 and FIG. 20 shows the operation in a vertical period next to the vertical period in FIG. 19.

As shown in FIG. 19, the operation in the vertical period next to the vertical period shown in FIG. 18 is described below. In a certain horizontal period TH3k, video signals are first written in the data lines D2, D5, and D8, then video signals are written in the data lines D3, D6, and D9, and finally video signals are written in the data lines D1, D4, and D7. In the next horizontal period TH3k+1, video signals are first written in the data lines D3, D6, and D9, then video signals are written in the data lines D1, D4, and D7, and finally video signals are written in the data-lines D2, D5, and D8. In the next horizontal period TH3k+2, video signals are first written in the data lines D1, D4, and D7, then video signals are written in the data lines D2, D5, and D8, and finally video signals are written in the data lines D3, D6, and D9.

As shown in FIG. 20, in the further next vertical period, in the horizontal period TH3k, video signals are first written in the data lines D3, D6, and D9, then video signals are written in the data lines D1, D4, and D7, and finally video signals are written in the data lines D2, D5, and D8. In the next horizontal period TH3k+1, video signals are first written in the data lines D1, D4, and D7, then video signals are written in the data lines D2, D5, and D8, and finally video signals are written in the data lines D3, D6, and D9. In the next horizontal period TH3k+2, video signals are first written in the data lines D2, D5, and D8, then video signals are written in the data lines D3, D6, and D9, and finally video signals are written in the data lines D1, D4, and D7. Operations other than the above of this embodiment are the same as those of the above-described fifth embodiment.

According to this embodiment, a sequence for writing a signal in a data line is differentiated for every vertical period and also differentiated for every horizontal period compared to the case of the above-described fourth and fifth embodiments. Therefore, it is possible to differentiate a data line which receives potential fluctuation for every vertical period and horizontal period. Thereby, it is more difficult for a person to recognize a luminance difference between pixels due to potential fluctuation and it is possible to more securely eliminate streak-like irregularity. Advantages other than the above mentioned of this embodiment are the same as those of the above-described fourth and fifth embodiments.

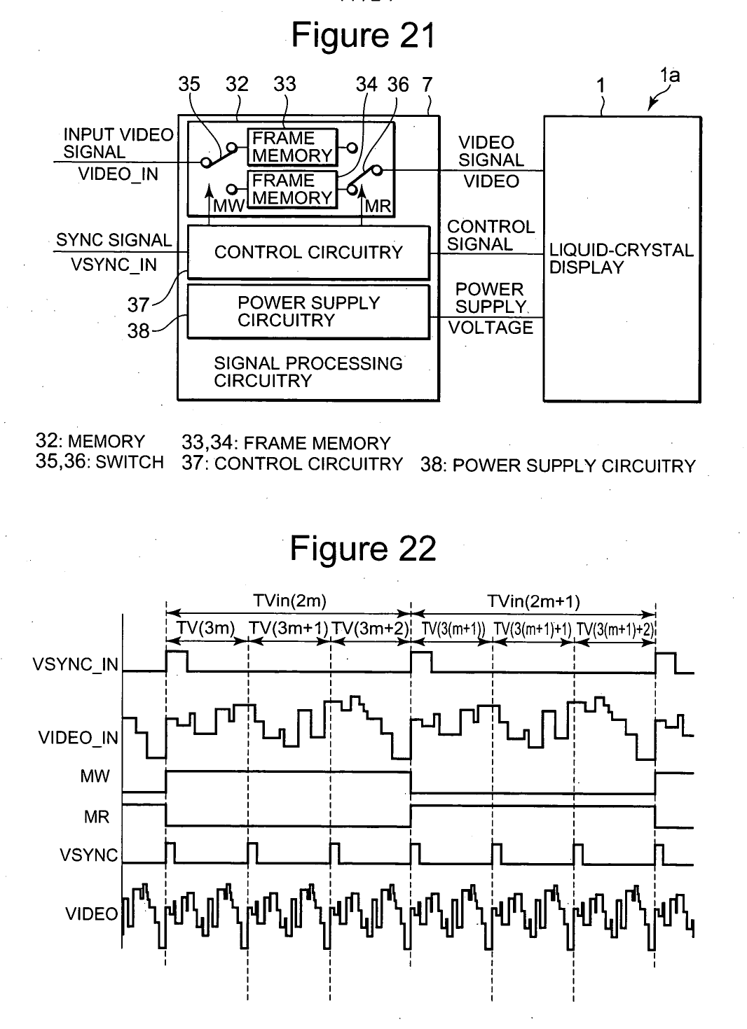

Then, seventh embodiment of the present invention is described. FIG. 21 is a block diagram showing a liquid-crystal display of this embodiment. As shown in FIG. 21, the liquid-crystal display 1a of this embodiment is obtained by setting signal processing circuitry 7 to the liquid-crystal display 1 of the above-described fourth embodiment. The sixth embodiment describes the above-described third embodiment more minutely. A configuration of the liquid-crystal display 1 is described for the above-described fourth embodiment.

An input video signal and a sync signal are supplied to the signal processing circuitry 7 from a signal source (not illustrated) for supplying video signals and the circuitry 7 supplies the video signal and the control signal to the liquid-crystal display 1 and also supplies various power-supply voltages necessary for the liquid-crystal display 1. The signal processing circuitry 7 is provided with a memory 32 capable of holding video signals supplied from the signal source for at least one screen. The memory 32 is provided with frame memories 33 and 34 respectively capable of holding video signals for one screen. Moreover, the memory 32 is provided with a switch 35 for selecting whether to input a video signal supplied from an external signal source to the frame memory 33 or 34 and a switch 36 for selecting whether to output a video signal stored in the frame memory 33 to the liquid-crystal display 1 or output a video signal stored in the frame memory 34 to the liquid-crystal display 1.

Furthermore, the signal processing circuitry 7 is provided with a control circuitry 37 to which a sync signal is input from a signal source and which outputs a memory control signal MW for controlling the switch 35 and a memory control signal MR for controlling the switch 36 and outputs a control signal to the liquid-crystal display 1. Furthermore, the signal processing circuitry 7 is provided with a power-supply circuitry 38 for generating various power-supply voltages and outputting the voltages to the liquid-crystal display 1.

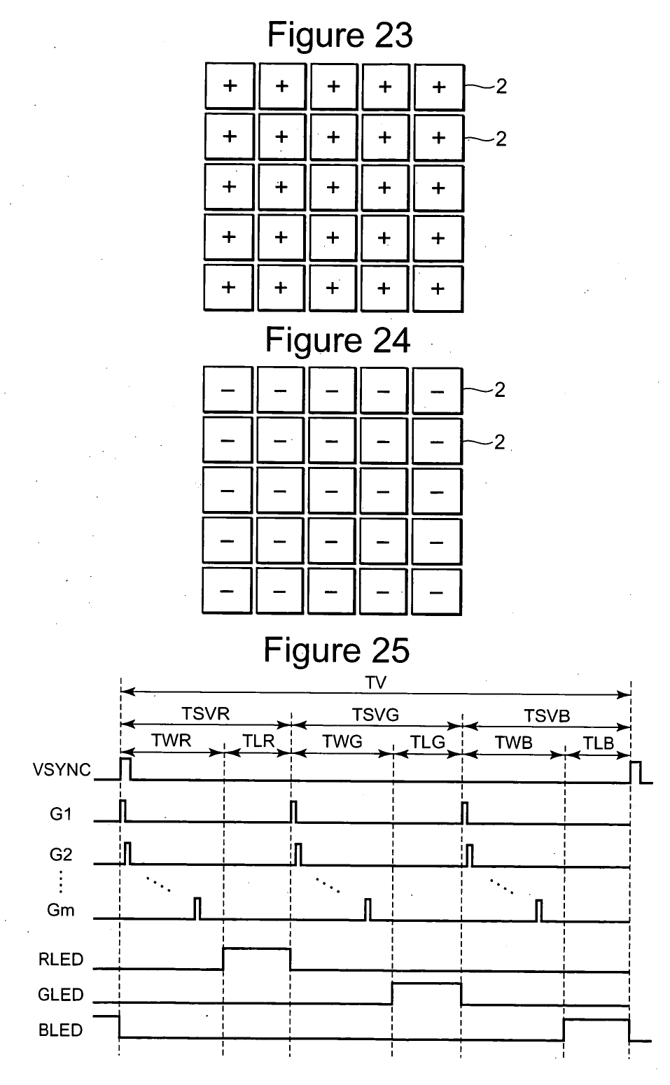

Then, operations of the liquid-crystal display of this embodiment constituted as described above, that is, a driving method of the liquid-crystal display of this embodiment are described below. FIG. 22 is a timing chart showing operations of the signal processing circuitry of this embodiment by assigning time to the axis of abscissa and potential of each wiring to the axis of ordinate. FIG. 23 is an illustration showing the polarity of a video signal to be applied to the pixel electrode of each pixel in a certain vertical period and FIG. 24 is an illustration sowing the polarity of a video signal to be applied to the pixel electrode of each pixel in a vertical period next to the vertical period in FIG. 23.

As shown in FIG. 22, a video signal VIODEO_IN output from a signal source is input to the signal processing circuitry 7 by synchronizing with a sync signal VSYNC_IN similarly output from the signal source. The video signal VIDEO_IN is an analog signal and the sync signal VSYNC_IN is a digital signal which becomes high-level only at the beginning of each vertical period of the video signal VIDEO_IN. The memory control signals MW and MR are signals for deciding writing a signal in the frame memory 33 or 34 and reading a signal from the frame memory 33 or 34 by controlling the switch 35 and 36 respectively.

In a certain vertical period TVin (2m), it is assumed that the memory control signal MW is kept high-level, the memory control signal MR is kept low-level, and therefore, the video signal VIDEO_IN supplied from a signal source is written in the frame memory 33, and the video signal VIDEO_IN is read from the frame memory 34. Then, in a vertical period TVin (2 m+1) continued from the vertical period TVin (2m), levels of the memory control signals MW and MR are reversed, a signal is written in the frame memory 34, and a signal is read from the frame memory 33. By performing the operations, a frequency conversion of reading a video signal supplied from a signal source with another frequency is realized. In the case of the example shown in FIG. 22, a video signal input from a signal source and stored in a frame memory is read at triple frequency and the same signal is supplied to the liquid-crystal display 1 three times in one vertical period of a video signal supplied from a signal source. Thereby, it is possible to compress the time width of the video signal VIDEO_IN to (⅓) times and supply a video signal VIDEO having a frequency three times higher than the frequency of the video signal VIDEO_IN to the liquid-crystal display 1.

Then, the liquid-crystal display 1 displays a video signal supplied from a signal source at triple speed for every three times. It is also allowed to apply any one of the methods of the above-described fourth to sixth embodiment to the operation of the liquid-crystal display 1 in this case. In this case, as shown in FIGS. 23 and 24, it is allowed that the liquid-crystal display 1 writes signals having the same polarity as a common electrode in all pixel electrodes in one vertical period for displaying video signals for one screen and perform the frame inversion for reversing the polarity for every vertical period. That is, it is allowed to write a signal having a positive polarity in a common electrode in the vertical period shown in FIG. 23 and a signal having a negative polarity to the common electrode in a pixel electrode in the next vertical period shown in FIG. 24.

Then, advantages of this embodiment are described below. In the case of this embodiment, a vertical period is shortened compared to the above-described fourth to sixth embodiments. Therefore, a cycle for changing a sequence for writing a video signal in a data line is further shortened and recognition of streak-like irregularity becomes more difficult. Thereby, it is possible that recognition of streak-like irregularity is made almost completely impossible.

Moreover, because the number of times for displaying the same video signal in one vertical period of an external signal is equal to the number of data lines (3 for this embodiment) for one output of data-line driving circuitry to perform time-division write, it is possible to almost equalize potential fluctuations generated in all data lines in one vertical period of the external signal and make recognition of a luminance difference between pixels due to potential fluctuation difficult.

Furthermore, by using a driving method for writing signals respectively having a polarity equal to that of a common electrode in all pixels in the period in which the liquid-crystal display displays a signal for a screen, it is possible to increase the numerical aperture of a liquid-crystal display and improve the using efficiency of light. A liquid-crystal display normally uses a driving method in which the polarity of a voltage to be applied to each pixel for every frame to a common electrode is reversed in order to prevent deterioration of liquid crystal and in this case, a driving method for applying signals having polarities different from each other to adjacent pixels is generally used. In the case of a liquid-crystal display for a projector, gate-line reverse driving for writing signals having the same polarity in each pixel row and applying signals whose polarities are different between adjacent pixel rows is frequently used in order to eliminate the influence of light leak due to disorder of orientation by changing polarities for every adjacent pixel rows, thereby decreasing flickers, setting a TFT and storage capacitor to positions along a gate line, thereby setting the position of light leak due to disorder of orientation of liquid-crystal molecules generated between adjacent pixels to a portion nearby a region in which the TFT and storage capacitor are arranged, and light-shielding the portion. However, in the case of a liquid-crystal display having a pixel pitch smaller than 20 μm, an area ratio between regions in which disorder of orientation of liquid-crystal molecules to a pixel region occurs increases but it is impossible to increase a numerical aperture and thus, there is a problem that the using efficiency of light is lowered.

However, like this embodiment, when performing frame inversion at a high frequency, it is possible to write signals having the same polarity in all pixel electrodes in a certain frame while avoiding the problem of flicker. Thereby, because signals having polarities different from each other are not written between adjacent pixel electrodes, light leak does not occur and it is possible to increase a numerical aperture. Therefore, it is possible to improve the using efficiency of light.

For this embodiment, an example in which a video signal is an analog signal is described. However, there is no problem even if processing the video signal as a digital signal.

Then, eighth embodiment of the present invention is described below. FIG. 25 is a timing chart showing operations of the liquid-crystal display of the eighth embodiment of the present invention by assigning time to the axis of abscissa and potential of each wiring to the axis of ordinate. Lights of red (R), green (G), and blue (B) successively emitted from a light source (not illustrated) are successively applied the liquid-crystal display of this embodiment. Because a configuration of the liquid-crystal display of this embodiment is the same as that of the above-described fourth embodiment, its description is omitted. The period TV shown in FIG. 25 is a vertical period in which video signals for one screen to be supplied to a liquid-crystal display from the outside are supplied.

In the case of this embodiment, the vertical period TV is divided into at least three subframe periods and each subframe period is divided into at least two periods. That is, the vertical period TV is divided into subframe periods TSVR, TSVG, and TSVB, the subframe period TSVR is divided into periods TWR and TLR, the subframe period TSVG is divided into a period TWG and TLG, and the subframe period TSVB is divided into periods TWB and TLB. In the period TWR, a video signal having a red component among video signals to be displayed on a liquid-crystal display is written and a light source applies red light to the liquid-crystal display in the period TLR. Similarly in the period TWG, a video signal having a green component is written and in the period TLG, the light source applies green light to the liquid-crystal display. Moreover, in the period TWB, a video signal having a blue component is written and in the period TLB, the light source applies blue light to the liquid-crystal display.

In the case of the liquid-crystal display of this embodiment, by performing field sequential driving, it is possible to display a color image in time division without setting a color filter to the liquid-crystal display. Advantages other than the above of this embodiment are the same as those of the above-described fourth embodiment.

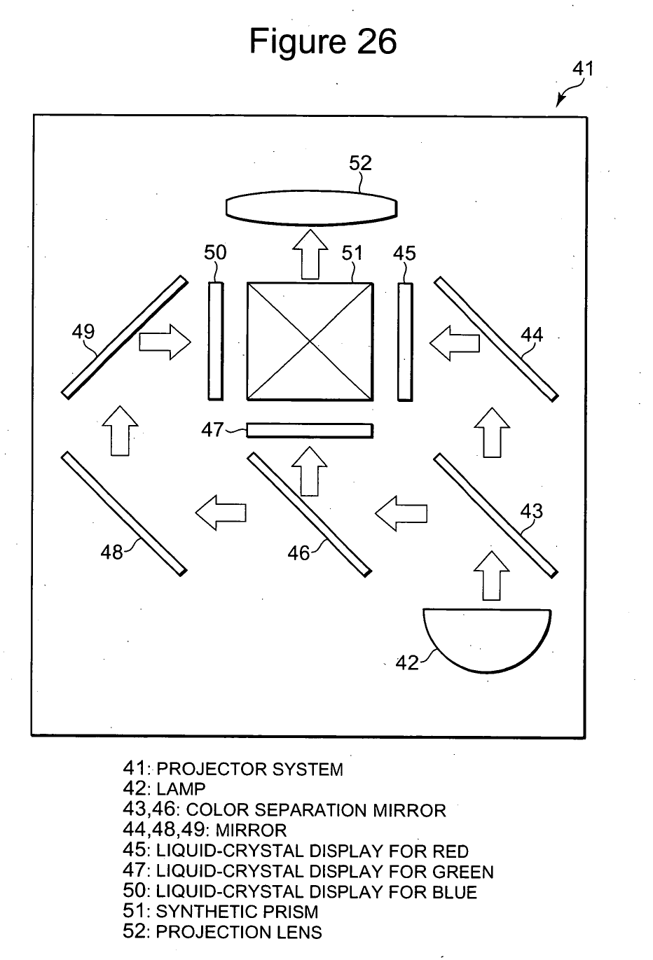

Then, ninth embodiment of the present invention is described. This embodiment is an execution conformation of a projector system. FIG. 26 is a block diagram showing the projector system of this embodiment. As shown in FIG. 26, the projector system 6f this embodiment is a liquid-crystal projector system using three liquid-crystal displays for lights of three primary colors of R, G, and B. A lamp 42 is set to the projector system 41 as a light source and a color separation mirror 43 for passing red light and reflecting green and blue lights is set to a position in an optical path of the light emitted from the lamp 42. An optical component (not illustrated) for uniforming light and an optical component (not illustrated) for arranging polarization of light are set between the lamp 42 and the color separation mirror 43.

Moreover, a mirror 44 for fully reflecting the light passing through the color separation mirror 43 and a liquid-crystal display 45 for red are set in order so as to be present in the optical path of the light. Furthermore, a color separation mirror 46 for reflecting green light and passing blue light is set so as to be present in the optical path of the light reflected from the color separation mirror 43 and a liquid-crystal display 47 for green light is set so as to be present in the optical path of the light reflected from the color separation mirror 46. Furthermore, mirrors 48 and 49 for fully reflecting the light passing through the color separation mirror 46 and a liquid-crystal display 50 for blue light are set in order so as to be present in the optical path of the light.

Furthermore, a synthesizing prism 51 for synthesizing the light passing through the liquid-crystal display 45 for red light, liquid-crystal display 47 for green light, and liquid-crystal display 50 for blue light is set and a projection lens 52 for widening the synthesized light emitted from the synthesizing prism 51 and projecting the light to an external screen (not illustrated) is set. The liquid-crystal display 45 for red light, liquid-crystal display 47 for green light, and liquid-crystal display 50 for blue light are single-light liquid-crystal displays and used for any one of the above-described embodiments.

Then, operations of the projector of this embodiment are described below. The liquid-crystal display 45 for red light, liquid-crystal display 47 for green light, and liquid-crystal display 50 for blue light display a red image, green image, and blue image respectively and a lamp 42 is turned on under this state. Thereby, the white light emitted from a lamp 52 is uniformed and polarization is uniformed. Thereafter, the light reaches the color separation mirror 43 and red component of the white light passes through the color separation mirror 43 and green component and blue component are reflected. Then, the red light passing through the color separation mirror 43 is reflected from the mirror 44, passes through the liquid-crystal display 45 for red light, and a red image is added to the red light.

Moreover, the light reflected from the color separation mirror 43 reaches the color separation mirror 46, green component is reflected from the color separation mirror 46, and blue component passes through the mirror 46. The green light reflected from the color separation mirror 46 passes through the liquid-crystal display 47 for green light and a green image is added to the green light. The blue light passing through the color separation mirror 46 is reflected from the mirrors 48 and 49, passes through the liquid-crystal display 50 for blue light and a blue image is added to the blue light.

Then, the red light to which the red image is added by the liquid-crystal display 45 for red light, green light to which the green image is added by the liquid-crystal display 47 for green light, and the blue light to which the blue image is added by the liquid-crystal display 50 for blue light are synthesized by the synthesizing prism 51, and these lights become color images and are light-widened and projected to a screen by the projection lens 52.

In the case of the projector system of this embodiment, streak-like irregularity along a data line hardly occurs in a liquid-crystal display built in the projector system. Therefore, streak-like irregularity hardly occurs also on a projected image. Therefore, a high-quality image having no irregularity is obtained even if increasing the number of display gradations compared to the case of a conventional liquid-crystal projector system.

It is allowed that a projector system of the present invention is a front-type liquid-crystal projector system or a rear-type liquid-crystal projector system.

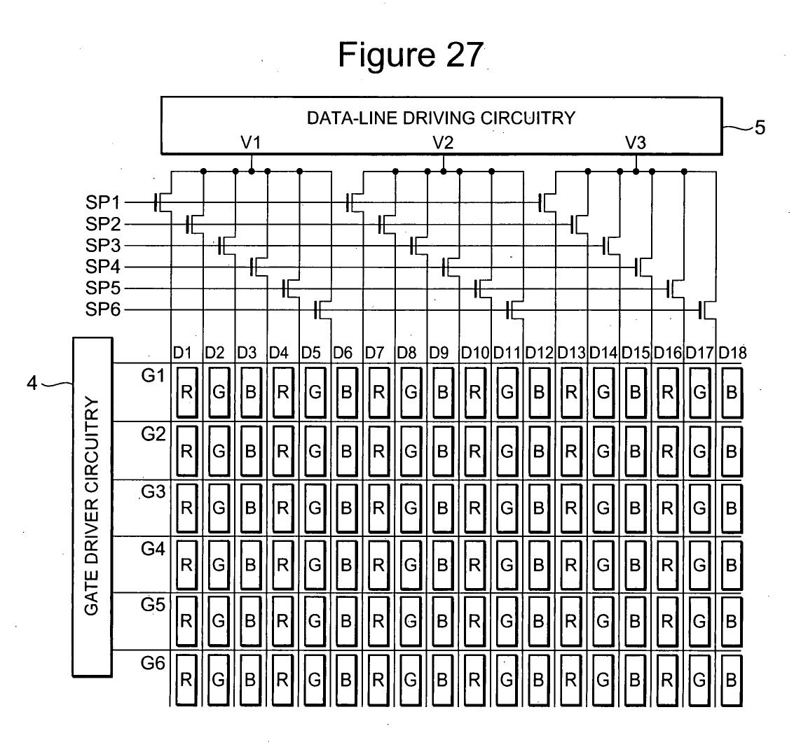

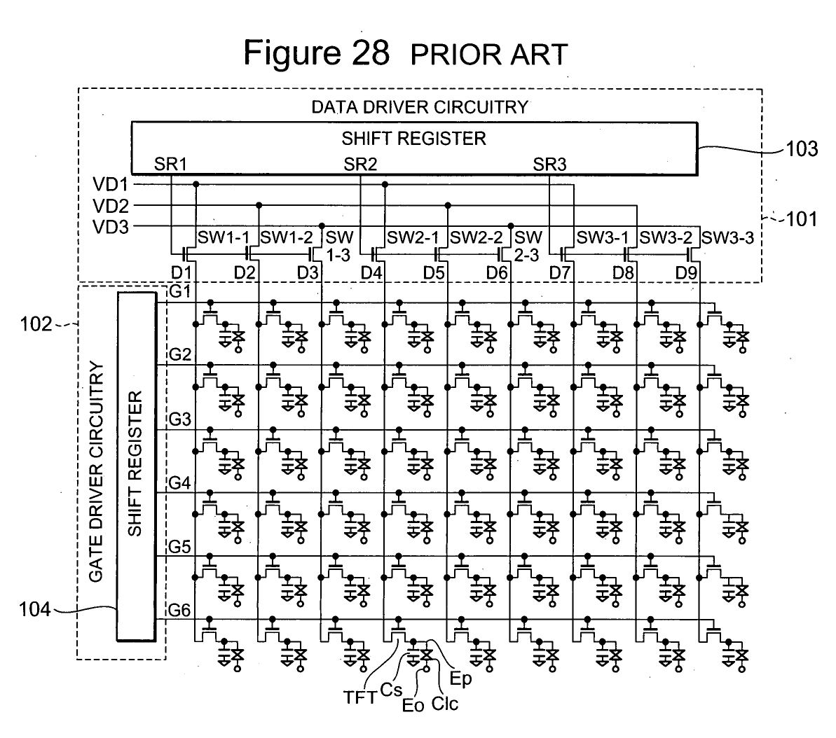

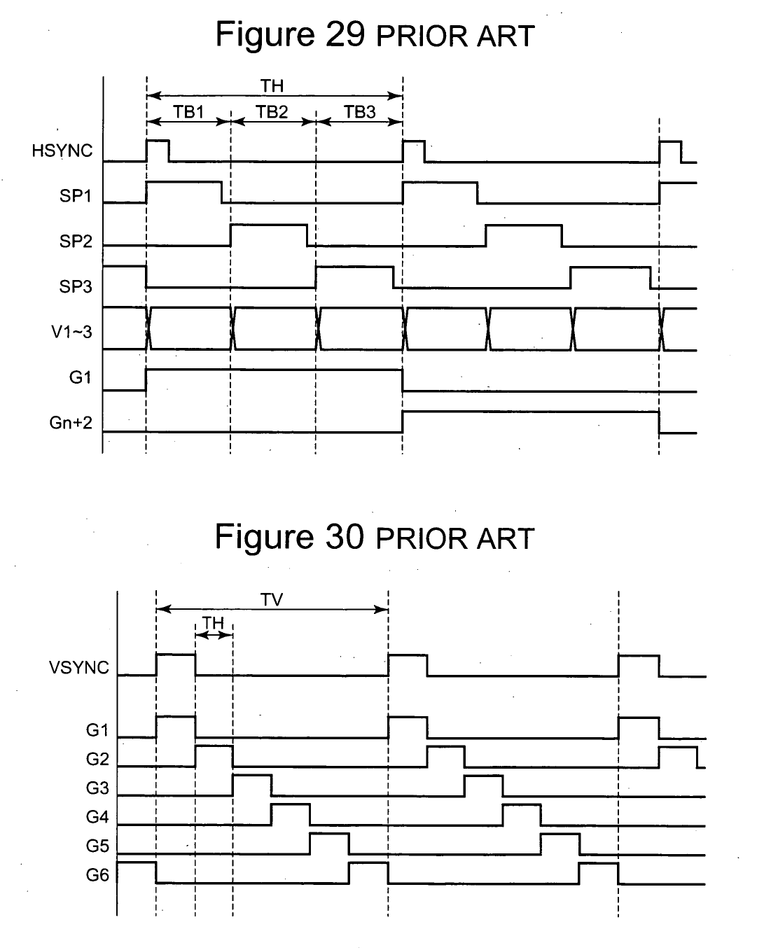

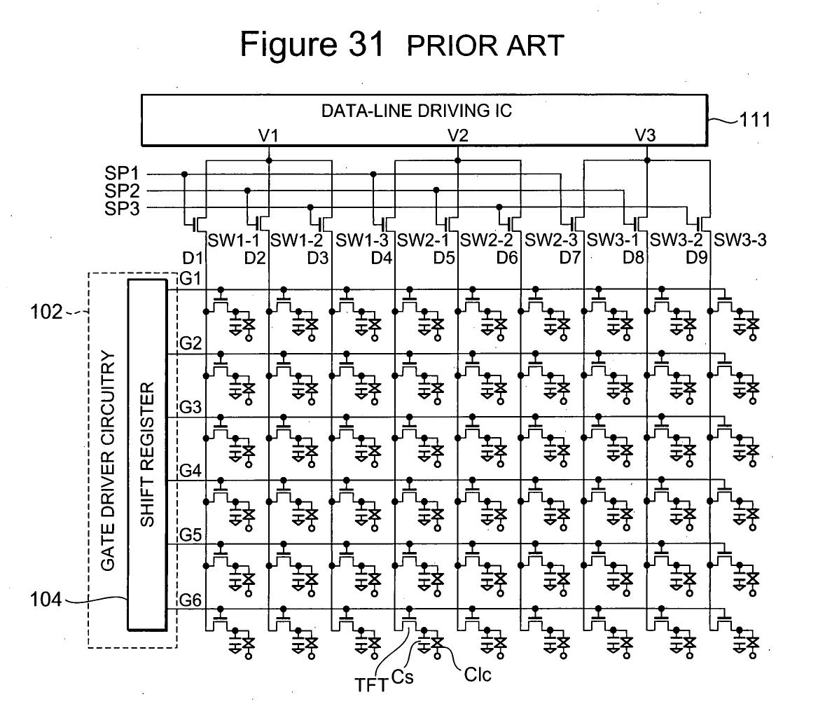

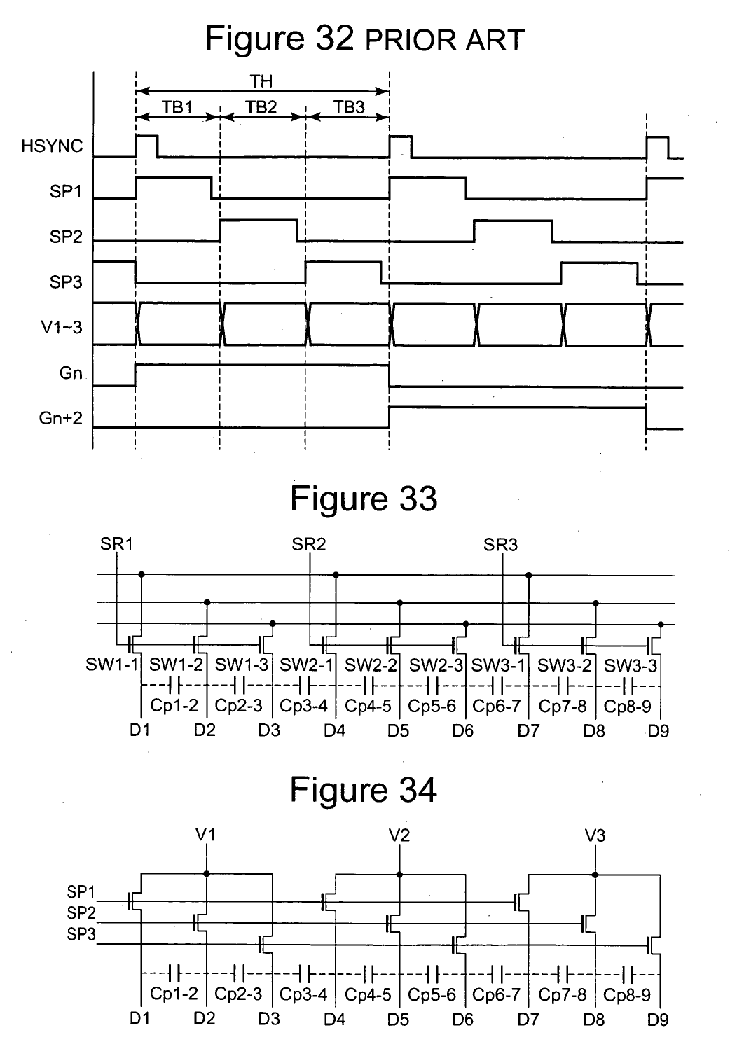

Then, tenth embodiment of the present invention is described below. FIG. 27 is a block diagram showing the liquid-crystal display of this embodiment. Symbols “R”, “G”, and “B” in FIG. 27 show colors of color filters arranged on each pixel. As shown in FIG. 27, in the case of the liquid-crystal display of this embodiment, a color filter of red (R), green (G), or blue (B) is set to each pixel. It is allowed to set the color filter to a TFT-side glass substrate or opposite-side glass substrate. Moreover, color filters of the same color are arranged in the row direction, that is, along the direction in which data lines D extend and color filters of different colors are arranged in the column direction, that is, along the direction in which gate lines. G extend. Moreover, in the case of this embodiment, the number of data lines D to be driven by one output of the data-line driving circuitry 5, that is, the number of data lines D belonging to one group is 6 and the number of colors of color filters is 3 or more. The driving method of the liquid-crystal display of this embodiment is the same as the case of the above-described fourth embodiment. It is also allowed to use the driving method of any one of the above-described embodiments 5 to 8.

When using a conventional liquid-crystal display, by setting the number of data lines to be driven by one output of data-line driving circuitry to 3 which is the same as the number of colors, even if potential fluctuations due to sampling occur, the fluctuation values are equalized for the same color. Therefore, recognition of streak-like irregularity is difficult compared to the case of differentiating the number of data lines to be driven by one output of data-line driving circuitry from the number of colors. However, when making the number of data lines to be driven by one output of data-line driving circuitry more than the number of colors, for example, when setting the number of data lines to be driven by one output to 4 or more and the number of colors to 3, data lines in which potential fluctuations are different occur even for the same color and streak-like irregularity becomes remarkable. However, in the case of this embodiment, even if making the number of data lines to be driven by one output of data-line driving circuitry more than the number of colors, streak-like irregularity is hardly recognized because potential fluctuations of data lines are temporally uniformed.

In the case of this embodiment, it is allowed to set color filters of a plurality of colors extending in the column direction, arrange pixels to which color filters of the same color are set in the column direction, that is, along the direction in which gate lines extend, and arrange pixels in which color filters of different colors are arranged in the row direction, that is, along the direction in which data lines extend. An advantage for eliminating streak-like irregularity is obtained. This is because when pixels in which color filters of the same color are set are arranged along the direction in which gate lines extend, even if noticing only a specific color, a signal is written at a timing in which a pixel for displaying the color differs in one horizontal period. This principle is the same as the case of the above-described liquid-crystal display for monochromatic display. As a result, by using the liquid-crystal display of this embodiment, it is possible to greatly decrease the number of streak-like irregularities.

For this embodiment, an example is shown in which the number of types of colors of color filters is set to three colors of R, G, and B. However, the present invention is not restricted to the above example. It is also allowed to use four colors of R, G, B, and W (white).

Moreover, the liquid-crystal display of each of the above described embodiments can be used as a display of a portable terminal unit such as a cellphone, Personal Digital Assistance (PDA: Portable information terminal), game machine, digital camera, or video camera.

There are a front-type liquid-crystal projector system, rear-type liquid-crystal projector system, and portable terminal unit as effectively using examples of the present invention.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents.

Further, it is the inventor's intent to retain all equivalents of the claimed invention even if the claims are amended during prosecution.

What is claimed is:

1. A liquid-crystal display comprising:
n times m data lines extending in a row direction and divided into m groups for every n lines adjacent to each other, n and m being integers of 2 or more;
a plurality of gate lines extending in a column direction;
a plurality of pixels set for every proximity point between said data lines and said gate lines;
gate driver circuitry for successively selecting said gate lines in one vertical period for displaying images for one screen; and
data driver circuitry for outputting video signals for one pixel row to said data lines in one horizontal period in which said gate driver circuitry selects one of said gate lines,
wherein said data driver circuitry comprises m output terminals set for each group of said groups to output the video signals, each k-th switch for switching whether to connect the k-th data line in each group to said output terminals, n k-th control lines connected to all the k-th switches in common, and driving circuitry for successively outputting a control signal for turning on the k-th switches to the k-th control lines and said driving circuitry differentiates a sequence for outputting the control signals to said n control lines in said horizontal period for predetermined period, k being an integer of 1 to n.

2. The liquid-crystal display according to claim 1, wherein said driving circuitry differentiates a sequence for outputting the control signals to said n control lines in said horizontal period for every said vertical period.

3. The liquid-crystal display according to claim 2, wherein there are n kinds of sequences for outputting the control signals, and wherein a switch turned on at the end of successive n horizontal periods is different from other switches turned on at the end of each sequence and wherein said driving circuitry repeatedly executes the n sequences for every cycle constituted of said vertical period of n times.

4. The liquid-crystal display according to claim 1, wherein said driving circuitry differentiates a sequence for outputting the control signals to the n control lines in the horizontal period for every said horizontal period of one time or a plurality of times.

5. The liquid-crystal display according to claim 4, wherein there are n kinds of sequences for outputting the control signals, and wherein a switch turned on at the end of successive n horizontal periods is different from other switches turned on at the end of each sequence and wherein said driving circuitry repeatedly executes the n sequences for every sub-period constituted of said horizontal period of n times.

6. The liquid-crystal display according to claim 1, wherein said driving circuitry differentiates a sequence for outputting the control signals to the n control lines in the horizontal period for every said horizontal period of one time or a plurality of times and for every said vertical period.

7. The liquid-crystal display according to claim 1, further comprising a signal processing circuitry comprised of a memory which stores video signals input from a signal source for at least one screen, wherein said signal processing circuitry reads the stored video signals for one screen at a frequency t times higher than a frequency when input from signal source, and outputs the read video signals to said data driver circuitry t times in a period in which video signals for the next one screen are input, t is an integer of 2 or more.

8. The liquid-crystal display according to claim 7, further comprising a first substrate on which said data lines and said gate lines are formed, a second substrate for holding a liquid-crystal layer with said first substrate, a pixel electrode which is set for every said pixel on said first substrate and to which the video signals are applied from said data lines, and a common electrode set on said second substrate wherein said data driver circuitry outputs the video signals having the same polarity as said common electrode to said data lines for any said vertical period.

9. The liquid-crystal display according to claim 7, wherein the value of t is equal to the value of n.

10. The liquid-crystal display according to claim 1, wherein said switches are respectively comprised of a thin-film transistor.

11. The liquid-crystal display according to claim 1, wherein a color filter is not used.

12. The liquid-crystal display according to claim 11, further comprising a light source for successively emitting color lights in said vertical period, wherein said gate driver circuitry scans said gate lines a plurality of times in said vertical period synchronously with operations of said light source, and said data driver circuitry successively outputs video signals corresponding to a plurality of color images in said vertical period synchronously with operations of said light source.

13. The liquid-crystal display according to claim 1, further comprising color filters of a plurality of colors extending in a row direction and arranged for every pixel column.

14. The liquid-crystal display according to claim 1, further comprising color filters of a plurality of colors extending in a column direction and arranged for every pixel column, wherein the number of data lines n included in each one of said groups is larger than the number of colors of color filters.

15. A portable terminal unit comprising the liquid-crystal display of claim 12.

16. A projector system having the liquid-crystal display of claim 1.

17. A projector system comprising:
a light source;
separator for separating the light emitted from said light source into lights of a plurality of colors;
a plurality of liquid-crystal displays of claim 11 present in optical paths of said separated lights to add an image to said separated lights when said separated lights pass; and
a prism for synthesizing the lights passing through said liquid-crystal displays.

18. A method of driving a liquid-crystal display, the liquid-crystal display comprising n times m data lines divided into m groups for every n lines extending in a row direction and adjacent to each other, n and m being integers of 2 or more, a plurality of gate lines extending in a column direction, and a plurality of pixels set for every proximity point between said data lines and said gate lines, comprising:
repeatedly displaying images for one screen on said pixels by successively selecting said gate lines and outputting the video signals to said data lines for every vertical period;
outputting video signals for one pixel row to said data lines for a horizontal period in which one of said gate lines is selected, and repeating it for all the gate lines for every said vertical period; and
successively outputting the video signals to the k-th data line in each one of said groups for every said horizontal period, k being an integer of 1 to n,
wherein differentiating a sequence for outputting the video signals to said n data lines in said horizontal period for predetermined period.

19. The method of driving a liquid-crystal display according to claim 18, wherein differentiating a sequence for outputting the video signals to said n data lines in said horizontal period is executed for every said vertical period.

20. The method of driving a liquid-crystal display according to claim 19, comprising n kinds of sequences for outputting the video signals, and wherein a switch turned on at the end of successive n horizontal periods is different from other switches turned on at the end of each sequence and wherein the n sequences are repeatedly executed for every cycle constituted of the vertical period of n times.

21. The method of driving a liquid-crystal display according to claim 18, wherein differentiating the sequence for outputting the video signals to said n data lines in the horizontal period is executed for every said horizontal period of one time or a plurality of times.

22. The method of driving a liquid-crystal display according to claim 21, comprising n kinds of sequences for outputting the video signals, and wherein a switch turned on at the end of successive n horizontal periods is different from other switches turned on at the end of each sequence and wherein the n sequences are repeatedly executed for every sub-cycle constituted of the horizontal period of n times.

23. The method of driving a liquid-crystal display according to claim 18, wherein differentiating the sequence for outputting the video signals to said n data lines in the horizontal period is executed for every said horizontal period of one time or a plurality of times and for every said vertical period.

24. The method of driving a liquid-crystal display according to claim 18, further comprising a step of storing video signals input from a signal source for one screen and a step of reading the stored video signals for one screen at a frequency t times higher than a frequency when input from a signal source and outputting the read video signals to the data lines t times, t being an integer of 2 or more, in a period in which video signals for the next one screen are input.

25. The method of driving a liquid-crystal display according to claim 24, wherein said liquid-crystal display comprises a first substrate on which said data lines and said gate lines are formed, a second substrate for holding a liquid-crystal layer with said first substrate, a pixel electrode which is set on said first substrate for every said pixel and to which the video signals are applied from said data lines, and a common electrode set on said second substrate, wherein the video signals having the same polarity as said common electrode is output to said data lines for any said vertical period.

26. The method of driving a liquid-crystal display according to claim 24, wherein the value of the t is made equal to the value of the n.

27. The method of driving a liquid-crystal display according to claim 18, wherein light of a plurality of colors are successively applied to said liquid-crystal display in the vertical period, and said gate lines are scanned several times in said vertical period synchronously with the operation of said light source and video signals corresponding to images of a plurality of colors are successively output.
